(19) United States
(12) Patent Application Publication
(10) Pub. No.: US 2015/0220975 A1
(43) Pub. Date: Aug. 6, 2015

(54) CLIENT ONLINE ACCOUNT MINIMUM ADVERTISED PRICE (MAP) POLICY MANAGEMENT APPLICATION SYSTEM, METHOD AND COMPUTER PROGRAM PRODUCT

(71) Applicant: Justin J. RYCHAK, Alexandria, VA (US)

(72) Inventor: Justin J. RYCHAK, Alexandria, VA (US)

(73) Assignee: LJ&L Enterprises, LLC, Alexandria, VA (US)

(21) Appl. No.: 14/171,576

(22) Filed: Feb. 3, 2014

(51) Int. Cl. G06Q 30/02

(52) U.S. Cl. CPC G06Q 30/0248; G06Q 30/0201

(57) ABSTRACT

A system, method or computer program product for minimum advertised price (MAP) policy and account management may include gathering online product pricing information from online sites advertising client product(s), including receiving client product and price information; receiving account information of the client including, e.g., name of an account advertising client product(s) or identifier of an online account site advertising the client product(s); gathering advertised client product and price information including: searching an online site (e.g., marketplace, aggregator, search engine, or account ecommerce site); saving the online advertised product and pricing data; and matching online advertised product and pricing data to client account; and presenting the online advertised product and price data related to the client product and pricing. The method may include communicating MAPP breaks to accounts; tracking communication history; measuring product advertising and/or search engine optimization effort; identifying prospects by effort measured; and/or client product placement by account.

### BACKGROUND OF THE INVENTION

1. Field of the Invention

The present invention relates generally to systems and methods for managing distribution policies, and more particularly for managing minimum advertised price policies.

2. Discussion of the Related Art

Conventionally, manufacturers distribute goods and services offerings through various distribution channels.

A marketing channel is a set of practices or activities necessary to transfer ownership of goods, and to move goods, from a point of production to a point of consumption, and may include all institutions and all marketing activities in the marketing process. A marketing channel is a useful tool for management. Roles of a marketing channel in marketing strategies may include a) linking producers to buyers, b) performing sales, c) advertising and promotion, d) influencing a firm's pricing strategy, e) affecting product strategy through branding, policies, and/or willingness to stock, and/or f) customizing profits, installing, maintaining, offering credit, etc. An example of a marketing channel for an apple orchard may flow from the apple orchard initially to transportation, to a processing factory, to packaging, to final products to be sold, e.g., an apple pie.

Other names for a marketing channel include a distribution channel, or a route-to-market. A distribution channel may be referred to as a path or pipeline through which products flow in one direction (e.g., from a manufacturer/vendor to a consumer), and payments generated by the sales of the products flow in an opposite direction (i.e., from the consumer to the manufacturer/vendor). A marketing channel can be as short as running directly from the vendor to the consumer, or may include a chain of several inter-connected (usually independent, but mutually dependent) intermediaries such as, e.g., but not limited to, a wholesaler, a distributor, an agent, and/or a retailer. Each intermediary may receive the exemplary good at one pricing point, and may move the good to a higher pricing point until it reaches a final buyer or consumer. Each link of the chain of the distribution channel may add value and/or mark up to the product's respective cost.

Many manufacturers have multiple channels of distribution. Many organizations use a mix of different channels, e.g., a manufacturer may have a combination of a direct sales-force for large customers, agents for smaller customers or prospects. A channel with no intermediaries includes so-called direct marketing. Since the arrival of the Internet's world wide web (WWW) in the 1990s, many products are increasingly sold over various online sales channels, or electronic commerce (“e-commerce”) channels. Online retailing and e-commerce has lead to disintermediation.

A manufacturing firm's marketing department manages distribution channels. The marketing department develops a marketing strategy which includes tailoring a product, its placement, pricing and promotion. Managing the channels may include seeking a range of suitable channels to market the firm's products. The firm then seeks to train and incentivize or encourage sales staff and intermediaries to sell the firm's products over a competitor's products, where a sales channel is not a captive sales force. The marketing department may use various tools to manage the various distribution channels. Another form of channel management may include entering into distribution and/or marketing agreements.

Management of distribution channels may also include managing channel conflict. Channel conflict can exist when one distribution channel is competing with another distribution channel. Vertical conflict occurs between levels of a channel, while horizontal conflict may occur between intermediaries at the same level within a channel.

Use of Minimum Advertised Pricing (MAP) policies impose restrictions on the price at which a product or service may be advertised, but do not restrict the actual sales price. A MAP policy is a unilateral policy and in no way limits a retailer's right to set its own prices. Retailers may advertise their price at or above the MAP price but can use other methods for selling at a lowerprice (e.g., “call for pricing,” “email for price,” “click for price,” or “add to cart to see price,” etc.). MAP policies are legal in the US under the US antitrust laws, and are reviewed under a rule of reason, since the decision in Leegin Creative Leather Products v. PSKS, Inc., U.S. Supreme Ct. of the U.S.(SCOTUS) (“Leegin”), in June 2007, which overruled the previous Dr. Miles Medical Co. v. John D. Park & Sons Co., decision of SCOTUS from 1911.

To help preserve their brand image and encourage providing high value customer service, a common practice among manufacturers is to implement MAP policies for their products.

With the advent of the Internet, it is becoming continually easier for new entities to create a sales presence online. The fleeting nature of the online medium makes it easier for a sales entity to advertise below a manufacturer client's MAP price for a client's product. Conventional methods of tracking and enforcing a client's MAP policy can be a time intensive and largely manual process.

Conventional channel management systems and methods and systems have various shortcomings as noted above. What is needed is an improved system and method that provides improved channel management tools that overcome various shortcomings of conventional solutions.

### Summary of Various Exemplary Embodiments of Invention

Various exemplary embodiments of a system, method and computer program product for providing an improved minimum advertised price (MAP) policy management application, system, method and/or computer program product for a client to manage online accounts, are set forth in detail herein.

According to one exemplary embodiment, a computer implemented method, system, and/or computer program product executable on a computer processor may include, according to an exemplary embodiment, an exemplary method, which may include a computer-implemented method of gathering online product pricing information from online sites advertising at least one product of a client, may include:
a. receiving, by at least one processor, at least one client product information and client product price information of the at least one client product;
b. receiving, by the at least one processor, account information of the client
   wherein the account information may include information regarding a name of an account advertising the at least one client products, and/or an identifier of an online account site advertising the at least one client product on the Internet;
c. gathering, by the at least one processor, advertised client product and advertised client product price information of at least one online account may include:
   i. searching, by the at least one processor, at least one online site
      where the at least one online site may include:
         at least one marketplace site,
         at least one aggregator site,
         at least one search engine site, and/or
         at least one account ecommerce site;
   ii. saving, by the at least one processor, the online advertised product data and the online advertised pricing data from the at least one online site related to the at least one client product and the client product pricing; and/or
   iii. matching, by the at least one processor, the online advertised product data and the online advertised pricing data to the at least one online account of the client; and/or
d. presenting, by the at least one processor, the online advertised product data and the online advertised product price data for the at least one online account of the client related to the client product and client product pricing.

According to one exemplary embodiment, the method may further include finding, by the at least one processor, the online advertised product data and the online advertised pricing data of the at least one online account, advertising the at least one client product below a minimum advertised price (MAP), which may include:
e. determining, by the at least one processor, the at least one online advertised product, corresponding to the at least one client product, advertised below MAP to obtain MAP break information, may include:
   i. comparing the advertised product information gathered for each account from the gathering against the client product information of the receiving may include:
      1. finding the online advertised product of the at least one client product advertised below the MAP, if any; and/or
      2. finding an actual advertised price of each of the online advertised product being advertised below the MAP; and/or
   ii. associating the map break information found in the comparing to a correct account based on the account information.

According to one exemplary embodiment, the method may further include
capturing digital evidence of account advertising products below MAP, which may include:
   f. capturing at least one digital image of at least one client product being advertised below MAP, may include:
      i. taking the at least one digital image may include at least a portion of a screen shot of an online page advertising the at least one client product below MAP;
      ii. capturing a universal remote locator (URL) of the actual advertised product price in account online advertising of the at least one client product; and/or
      iii. associating the at least one digital image with the correct account and client product.

According to one exemplary embodiment, the method may further include
finding at least one unauthorized account advertising the at least one client product online, may include:
   g. identifying the captured data from at least one crawl that does not match a known client accounts, may include:
      i. finding at least one previously unknown account advertising the at least one client product;
      ii. finding a total number of the at least one client product on which the previously unknown account is advertising;
      iii. finding for the previously unknown account, any advertising of the at least one client product below MAP;
      iv. finding a below MAP advertised client product of the at least one client product, if any, which the previously unknown account is advertising below MAP; and/or
      v. finding a below MAP advertised price of the below MAP advertised client product, which the previously unknown account is advertising below MAP.

According to one exemplary embodiment, the method may further include
facilitating managing or enforcing of a MAP policy online for the client, may include at least one of:
   a. displaying account map break findings may include:
      i. presenting account level aggregate map break results may include at least one of the total number of products found; and/or the total number of products listed below MAP found;
      ii. presenting specific account level results may include at least one of: the actual links to online pages with online advertised product and online advertised product price advertised below MAP; the at least one digital image of the at least the portion of the screen shot of the online page with the advertised product and the actual advertised product price advertised below MAP; and/or
   b. providing a notification to an account of the MAP break of the account, if any, the providing may include:
      i. creating an email template customizable by the client based on a MAP policy of the client, may include:
         1. creating a specific email with a customized template message of the client; and/or
         2. customizing the specific email containing the actual MAP break information for each account showing the actual MAP break information may include:
         a. the online advertised product that account has listed below MAP;
         b. the online advertised price of each online advertised product advertised below MAP by the account;
         c. the correct MAP price the account should not be advertising below;
         d. the URL including a hyperlink to the online page advertising the at least one client product and the actual advertised product price; and/or
         e. a hyperlink to a stored date-stamped copy of the at least one digital image of the at least the portion of the screen shot of the online page advertising the at least one client product below MAP;
      ii. sending at least one customized MAP break email to each account based on the MAP break of the account, if any; and/or
      iii. tracking a history of the at least one customized MAP break email sent to each account.

According to one exemplary embodiment, the method may include
where the gathering may further include:
   measuring an external product-level marketing effort by the at least one online account of advertising the at least one client product, which may include:
      i. adding up a total number of products found for each account;
      ii. analyzing a total number of products found versus the total number of the client products the client has given the account to sell; and/or
      iii. assigning at least one ranking for each account based on the total number of products found for each account; and/or
      iv. grading each account based on the total number of products found verses the total number of products the clients is giving account to sell; and/or
   where the presenting further may include at least one of:
      i. presenting account level aggregate results;
      ii. presenting account level aggregate results may include the total number of products found;
      iii. presenting actual account level product results; and/or
      iv. providing sorting of accounts based on the efforts.

According to one exemplary embodiment, the method may further include
identifying effort at least one online account of the client is making to appear on a top page of at least one search engine for at least one of: at least one top customer search, and/or at least one product niche related to the client, which may include:
e. determining the at least one top customer search in the at least one search engine related to the client products;
f. crawling the at least one search engine site for search results for the at least one top customer search;
g. gathering at least one account name and at least one site found in the search results for the at least one top customer search;
h. associating the at least one top customer search values to the at least one account or the account online site of the account information;
i. adding up a sum of the total number of times the at least one account appeared in the at least one top customer search; and/or
j. grading each of the at least one account based on the total number of times the account appeared in the top customer searches versus to the total number of searches made; and/or

where the (d) presenting, may include at least one of:
i. presenting the account level aggregate results;
ii. presenting the account level aggregate results may include the total number of times the account was found;
iii. presenting the account level aggregate results may include the grade of the account; and/or
iv. providing sorting of the at least one account based on the effort.

According to one exemplary embodiment, the method may further include
where the identifying prospective accounts making an effort to appear on the at least one top page of the search engine results for the top customer searches or the product niches related to the client, may further include:
   g. determining the top customer searches in search engines related to the products offered by client;
   h. crawling Search Engine website for these top customer searches;
   i. gathering the account names and websites that were found in the search results for the top customer searches;
   j. filtering out existing accounts of the client; and/or
   k. presenting those accounts who are appearing in search engine results who are not current accounts of the client.

According to one exemplary embodiment, another exemplary system, method, or computer program product may include, a system of gathering online product pricing information from online sites advertising at least one product of a client, which may include:

at least one memory; and
at least one computer processor coupled to the at least one memory,
wherein the at least one computer processor is operative to:
   receive at least one client product information and client product price information of the at least one client product;
   receive account information of the client
      wherein the account information may include information regarding a name of an account advertising the at least one client products, and/or an identifier of an online account site advertising the at least one client product on the Internet;
   gather advertised client product and advertised client product price information of at least one online account may include:
      search at least one online site
         wherein the at least one online site may include:
         at least one marketplace site,
         at least one aggregator site,
         at least one search engine site, and/or
         at least one account ecommerce site;
      save the online advertised product data and the online advertised pricing data from the at least one online site related to the at least one client product and the client product pricing; and
      match the online advertised product data and the online advertised pricing data to the at least one online account of the client; and
present the online advertised product data and the online advertised product price data for the at least one online account of the client related to the client product and client product pricing.

According to one exemplary embodiment, the system may further include the processor operative to:
find the online advertised product data and the online advertised pricing data of the at least one online account, advertising the at least one client product below a minimum advertised price (MAP), may include being operative to:
   determine the at least one online advertised product, corresponding to the at least one client product, advertised below MAP to obtain MAP break information, may include:
      compare the advertised product information gathered for each account from the gathering against the client product information of the receiving may include:
         find the online advertised product of the at least one client product advertised below the MAP, if any; and
         find an actual advertised price of each of the online advertised product being advertised below the MAP; and
      associate the map break information found in the comparing to a correct account based on the account information.

According to one exemplary embodiment, the system may further include the processor operative to capture digital evidence of account advertising products below MAP, may include:
capture at least one digital image of at least one client product being advertised below MAP, may include:
   take the at least one digital image may include at least a portion of a screen shot of an online page advertising the at least one client product below MAP;
   capture a universal remote locator (URL) of the actual advertised product price in account online advertising of the at least one client product; and/or associate the at least one digital image with the correct account and client product.

According to one exemplary embodiment, the system may further include the processor operative to identify the captured data from at least one crawl that does not match a known client accounts, which may include the processor operative to:
find at least one previously unknown account advertising the at least one client product;
find a total number of the at least one client product on which the previously unknown account is advertising;
find for the previously unknown account, any advertising of the at least one client product below MAP;
find a below MAP advertised client product of the at least one client product, if any, which the previously unknown account is advertising below MAP; and/or
find a below MAP advertised price of the below MAP advertised client product, which the previously unknown account is advertising below MAP.

According to one exemplary embodiment, the system may further include the processor operative to facilitate managing or enforcing of a MAP policy online for the client, which may include the processor operative to at least one of:
display account map break findings may include:
   present account level aggregate map break results may include at least one of the total number of products found; or the total number of products listed below MAP found;
   present specific account level results may include at least one of: the actual links to online pages with online advertised product and online advertised product price advertised below MAP; the at least one digital image of the at least the portion of the screen shot of the online page with the advertised product and the actual advertised product price advertised below MAP; and/or
provide a notification to an account of the MAP break of the account, if any, the providing may include:
   create an email template customizable by the client based on a MAP policy of the client, may include:
      create a specific email with a customized template message of the client; and/or
      customize the specific email containing the actual MAP break information for each account showing the actual MAP break information may include:
         the online advertised product that account has listed below MAP;
         the online advertised price of each online advertised product advertised below MAP by the account;
         the correct MAP price the account should not be advertising below;
         the URL including a hyperlink to the online page advertising the at least one client product and the actual advertised product price; and/or
         a hyperlink to a stored date-stamped copy of the at least one digital image of the at least the portion of the screen shot of the online page advertising the at least one client product below MAP;
   send at least one customized MAP break email to each account based on the MAP break of the account, if any; and/or
   track a history of the at least one customized MAP break email sent to each account.

According to one exemplary embodiment, the system wherein the gather further may include wherein the processor is operative to:
measure an external product-level marketing effort by the at least one online account of advertising the at least one client product, which may include the processor operative to at least one of: add up a total number of products found for each account;
   analyze a total number of products found versus the total number of the client products the client has given the account to sell; and/or
   assign at least one ranking for each account based on the total number of products found for each account; and/or
   grade each account based on the total number of products found verses the total number of products the clients is giving account to sell; and/or
wherein the (d) of the presenting further may include at least one of:
present account level aggregate results;
present account level aggregate results may include the total number of products found;
present actual account level product results; and/or
provide sorting of accounts based on the efforts.

According to one exemplary embodiment, the system wherein the processor is further operative to:
identify effort at least one online account of the client is making to appear on a top page of at least one search engine for at least one of: at least one top customer search, or at least one product niche related to the client, may include:
determine the at least one top customer search in the at least one search engine related to the client products;
   crawling the at least one search engine site for search results for the at least one top customer search;
gather at least one account name and at least one site found in the search results for the at least one top customer search;
associate the at least one top customer search values to the at least one account or the account online site of the account information;
add up a sum of the total number of times the at least one account appeared in the at least one top customer search; and/or
grade each of the at least one account based on the total number of times the account appeared in the top customer searches versus to the total number of searches made; and
   wherein the present, may include wherein the processor is operative to at least one of:
      present the account level aggregate results;
      present the account level aggregate results may include the total number of times the account was found;
      present the account level aggregate results may include the grade of the account; and/or
      provide sorting of the at least one account based on the effort.

According to one exemplary embodiment, wherein the system is operative to identify prospective accounts making an effort to appear on the at least one top page of the search engine results for the top customer searches or the product niches related to the client, wherein the processor is further operative to: determine the top customer searches in search engines related to the products offered by client; crawl Search Engine website for these top customer searches; gather the account names and websites that were found in the search results for the top customer searches; filter out existing accounts of the client; and/or present those accounts who are appearing in search engine results who are not current accounts of the client.

According to another exemplary embodiment, a computer implemented system, method and/or computer program product may provide an exemplary computer program product embodied on a nontransitory computer accessible medium, may include program logic, which when the program logic is executed on at least one computer processor performs a method which may include:
a. receiving, by at least one processor, at least one client product information and/or client product price information of the at least one client product;
b. receiving, by the at least one processor, account information of the client
   wherein the account information may include information regarding a name of an account advertising the at least one client products, and/or an identifier of an online account site advertising the at least one client product on the Internet;
c. gathering, by the at least one processor, advertised client product and advertised client product price information of at least one online account may include:
   i. searching, by the at least one processor, at least one online site
      wherein the at least one online site may include:
         at least one marketplace site,
         at least one aggregator site,
         at least one search engine site, and/or
         at least one account ecommerce site;
   ii. saving, by the at least one processor, the online advertised product data and the online advertised pricing data from the at least one online site related to the at least one client product and the client product pricing; and
   iii. matching, by the at least one processor, the online advertised product data and the online advertised pricing data to the at least one online account of the client; and
d. presenting, by the at least one processor, the online advertised product data and the online advertised product price data for the at least one online account of the client related to the client product and client product pricing.

According to another exemplary embodiment, a computer implemented system, method and/or computer program product may provide an application for identifying effort of at least one online account of a client is making to appear on at one top page of at least one search engine for at least one of: at least one top customer search, or at least one product niche related to the client, which may include, according to an exemplary embodiment:
a. receiving client product information from the client;
b. receiving account information of the client,
   wherein the account information may include a name of the account advertising at least one client product, or an actual account website advertising the at least one client product on the Internet;
c. determining at least one top customer search in at least one search engine related to the at least one client product offered by client;
d. crawling at least one search engine website for the at least one top customer search to obtain at least one search result;
e. gathering the account name and website found in the at least one search result for the at least one top customer search;
f. associating the at least one top customer search value with the account or the account website;
g. adding up a total number of times a given account appeared in the at least one top customer search;
h. grading each of the account based on the total number of times the account appeared in the at least one top customer search out of the total number of searches made; and
   wherein the presenting information found on client products, further may include:
v. presenting account level aggregate results, such as the total number of times the account was found and the grade of the account; and/or
vi. providing functionality of sorting accounts based on efforts.

According to another exemplary embodiment, the computer implemented method may include:
identifying prospective accounts making the effort to appear on the at least one top page of the search engine results for the top customer searches or the product niches related to the client, further may include:
   i. determining the top customer searches in search engines related to the products offered by client;
   j. crawling Search Engine website for these top customer searches;
   k. gathering the account names and websites that were found in the search results for the top customer searches;
   l. filtering out existing accounts of the client; and/or
   m. presenting those accounts who are appearing in search engine results who are not current accounts of the client.

According to another exemplary embodiment, the computer implemented method may further include:
identifying at least one product placement of the at least one client product on at least one online website of at least one account, may include:
   e) identifying at least one website page of the at least one account where the at least one client product and at least one product of at least one client competitor are listed advertised;
   f) gathering the at least one product placement of the client on the at least one website page of the at least one account, the gathering may include:
i. crawling the at least one online website page of the at least one account;
ii. finding where the at least one client product is ranked amongst all products listed as advertised on the at least one online website page of the at least one online website of the at least one account; and
iii. saving the client product, and client product rank found on the at least one online website page of the at least one account, along with a date and a time of the gathering;
   g) determining an average number of the at least one client products found and an average position of the at least one client products found over at least one time frame, may include at least one of the at least one timeframe, a last 24 hours, a last week, and/or a last month, etc.; and/or
   h) presenting at least one of:
i. the at least one client product found and the client product rank, along with the date and time of the gathering;
ii. the average number of products found during the at least one time frame; and/or
iii. the average position of products found during the at least one time frame.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1A depicts an exemplary view of an exemplary embodiment of an exemplary heterogeneous client device environment coupled to an exemplary network system capable of delivering online electronic commerce sales to various users, and adapted, according to an exemplary embodiment, to provide a client online account minimum advertised price (MAP) policy management application system, method and computer program product, hardware application system architecture environment, including an exemplary plurality of client and/or server computing and/or communication devices coupled together in a distributed networked system architecture;

FIG. 1B depicts an exemplary embodiment of a network-based MAP policy management system, system architecture high level diagram, according to an exemplary embodiment, which may be coupled together by an exemplary cloud-based architecture network, according to an exemplary embodiment;

FIG. 1C depicts an exemplary embodiment of an exemplary system architecture illustrating an exemplary distributed user and exemplary minimum advertised price (MAP) policy management service provider network environment, exemplary manufacturer client application server, and exemplary online account advertiser of the client products of the client, according to an exemplary embodiment;

FIG. 1D depicts an exemplary embodiment of an exemplary system illustrating an exemplary distributed network environment, with exemplary load balancing and exemplary meshed fault tolerance, which may be used to couple exemplary user devices to an exemplary MAP policy management service provider application server, according to an exemplary embodiment;

FIG. 2 depicts an exemplary embodiment of an exemplary graphical user interface (GUI) exemplary partial screenshot depicting an exemplary user interface of an exemplary Matched Accounts listing screen of an exemplary user view of an exemplary client's matched accounts, according to an exemplary embodiment. according to one exemplary embodiment;

FIG. 3 depicts an exemplary embodiment of a diagram illustrating an exemplary user interface screenshot for an exemplary embodiment of an application representing receiving of client's account information (i.e., information regarding the name of an account advertising one or more of the client's products and/or the actual account websites that are advertising for sale client products on the internet;

FIG. 4 depicts an exemplary image, illustrating an example of an account and the account's MAP break information listed for an exemplary specific account (e.g., janedoelight.com), according to an exemplary embodiment;

FIG. 5 depicts an exemplary diagram illustrating an exemplary computer/communications device hardware architecture as may be used in various components of exemplary embodiments of the present invention, according to an exemplary embodiment;

FIG. 6 depicts an exemplary image illustrating an example of a record capturing an instance of an actual MAP break by an account, and exemplary information about the MAP break, according to an exemplary embodiment;

FIG. 7 depicts an exemplary screenshot image of an exemplary webpage (or portion thereof) captured of an exemplary MAPP break showing advertising of an exemplary account of the client product (illustrated is an example candleholder) and actual account pricing information for the client product, as well as the client account name 702 (i.e., illustrated is an example account name “John Doe Home”), according to an exemplary embodiment;

FIG. 8 depicts an exemplary image screenshot illustrating an example of capturing a universal resource locator (URL) of an actual account's exemplary webpage of an exemplary website, which is advertising for sale the client product, of the account which is advertising the client product below MAP;

FIG. 9 depicts an exemplary image screenshot illustrating a screen providing an exemplary table of examples of un-matched accounts, who were found advertising a client product online, according to an exemplary embodiment;

FIG. 10 depicts an exemplary image screenshot illustrating an exemplary screen of an exemplary user interface table, by which a user may view and interactively access exemplary MAPP break information, according to an exemplary embodiment;

FIG. 11 depicts an exemplary image screenshot illustrating an exemplary screen including an exemplary image showing how a client may have the ability to create client customizable template emails to enforce the client's MAP policy, according to an exemplary embodiment;

FIG. 12 depicts an exemplary image screenshot illustrating an exemplary screen including an exemplary image illustrating an exemplary user interface displaying an exemplary list of accounts, exemplary map breaks associated with each account, and providing, in an exemplary embodiment, the featured ability to receive a selection of which accounts the exemplary client user may want to email;

FIG. 13 depicts an exemplary image screenshot illustrating an exemplary screen, which may include an exemplary image showing an exemplary feature, which may be used by a client user to provide an ability for an exemplary client to pursue enforcing the client's MAP policy;

FIG. 14 depicts an exemplary image screenshot illustrating an exemplary screen, which may include an exemplary user interface showing an exemplary aggregate level results under “Product Level Effort” heading where you see Effort (Grade) and Rank (list from 1 to total # of accounts) in an exemplary embodiment, wherein this information may relate to presenting information found on products and pricing, and presenting account level aggregate results: such as the total number of products found. as well as, assigning rankings for each account based on number of products found for each accounts, grading each account based on the total number of products found versus the total number of products the clients is giving an account to sell, according to an exemplary embodiment;

FIG. 15 depicts an exemplary image screenshot illustrating an exemplary screen, which may include showing an exemplary specific account level, including how the system searched for client product(s) and found the account advertising, resulting in the account having a grade of “Good”;

FIG. 16 depicts an exemplary image screenshot illustrating an exemplary screen, which may include showing an exemplary aggregate level results under “SEO Marketing Effort” heading where Effort (Grade) and Rank (list from 1 to total # of accounts), according to an exemplary embodiment;

FIG. 17 depicts an exemplary image screenshot illustrating an exemplary screen, which may include an exemplary bottom left meter (Very Good) showing the SEO effort the account is making and the results that this account appeared in the top 265 of 396 customer search/product niches for this client, according to an exemplary embodiment;

FIG. 18 depicts an exemplary image screenshot illustrating an exemplary screen, which may include an example of the output of various steps, which may include, c. gathering the account names and websites that were found in the search results for the top customer searches, which identifies prospective accounts, we often refer to it as our “prospect manager” because it helps client's identify ecommerce sites succeeding online who they may to pitch to sign up and carry its products; d. filtering out existing accounts of the client; and e. presenting those accounts who are appearing in search engine results who are not current clients, according to an exemplary embodiment;

FIG. 19 depicts an exemplary flow diagram of a MAPP management method of managing a client's accounts, and reviewing account advertised pricing of client products, including optional identifying of nonmatching accounts, and optional effort measurement and ranking, according to an exemplary embodiment;

FIG. 20 depicts an exemplary flow diagram of a MAPP management method of determining MAP breaks, according to an exemplary embodiment;

FIG. 21 depicts an exemplary flow diagram of a MAPP management method of capturing images of identified MAP breaks, providing for optional automated notifications, and optional notification history creation and access, according to an exemplary embodiment;

FIG. 22 depicts an exemplary high level diagram overviewing how an exemplary MAPP management method works, according to an exemplary embodiment;

FIG. 23 depicts an exemplary high level description overviewing various exemplary modules of an exemplary MAPP management method, according to an exemplary embodiment;

FIG. 24 depicts an exemplary high level description overviewing various additional exemplary modules of an exemplary MAPP management method, according to an exemplary embodiment; and

FIG. 25 depicts an exemplary software architecture diagram, according to an exemplary embodiment.

### DETAILED DESCRIPTION OF EXEMPLARY EMBODIMENTS OF THE INVENTION

Various exemplary embodiments of the invention are discussed in detail below. While specific exemplary embodiments are discussed, it should be understood that this is done for illustration purposes only. Exemplary means example for purposes of this application, and various embodiments need not include all features as described herein. A person skilled in the relevant art will recognize that other components and configurations can be used without parting from the spirit and scope of the invention.

### Introduction and Overview

According to an exemplary embodiment, an exemplary image snap shot feature of an exemplary MAP profile management application solution may automatically crawl the Internet and capture screen shot images of a client's products being advertised below MAPP. In an exemplary embodiment, the automated system may match the images to a client manufacturer's online account. With this information, client manufacturers using another exemplary feature, may also quickly reach out to MAPP breakers using an exemplary email manager system. An exemplary embodiment of the present invention may provide a solution, which may include, e.g., but not limited to, automating MAPP break tracking; easily managing accounts by sending emails including images and links to pages indicating MAPP breaks; tracking a client's accounts' MAPP break history with an exemplary history dashboard; detecting rogue accounts; understanding effort, which the client's accounts are making an effort to advertise the client's products & attracting customers to purchase the client products; and/or quickly managing advertising of client products & advertising of client product price, including tracking client products with an easy product manager, etc.

### Introduction to Exemplary Embodiments

According to an exemplary embodiment, an exemplary minimum advertised price (MAP) policy management tool and associated business intelligence tools, are set forth.

Clients have More MAPP Breaking Accounts than they Realize

A typical client's total number of MAPP breaking instances is 5 to 20 times greater than what the client may think the number of MAPP breaks actually is. Conventionally, it has been usually very difficult to identify MAPP breakers and then to tell the account breaking MAPP, how and where to make corrections.

According to Forrester Research, online purchases will continue to grow at a compounded rate of 10% per year with some industries growing as high as 40%. To account for this growth, managing a client's MAP policy is critical to avoid channel discord, according to an exemplary embodiment. The MAP policy management system, according to an exemplary embodiment, may allow a client to do just that, according to an exemplary embodiment.

### Find MAPP Breakers

It is a delicate balance, 1) a client needs to facilitate good relationships with accounts; 2) a client needs to facilitate a MAP policy to protect the client's brand and promote healthy, fair competition among retailers according to an exemplary embodiment. The MAP policy management system, according to an exemplary embodiment may help a client do both, according to an exemplary embodiment. The innovative technology, according to an exemplary embodiment, may scour the Internet in search of client products, according to an exemplary embodiment.

### Automate Client MAPP Management

With the MAP policy management tool, according to an exemplary embodiment, the auto-management module may, e.g., but not limited to, a) automatically start crawlers; b) automatically perform quality assurance (Q/A) on returned data; c) automatically merge data with client accounts; d) automatically send each account communications, such as, e.g., but not limited to, notification and/or an email including data and/or a screen shot for the client products, whose advertising, the account needs to update, etc., according to an exemplary embodiment. The MAP policy management system, according to an exemplary embodiment can help a client to effectively find MAPP breakers and may reduce the amount of time that a client may need to manage the process, by automating various phases of identifying, collecting evidence, and notifying/remediating identified policy breaks, according to an exemplary embodiment.

### Measure the Effort of a Client's Accounts

One of the biggest challenges for a wholesaler or manufacturer tasked with managing Internet accounts is understanding the level of effort the accounts are making in marketing a client's products, according to an exemplary embodiment. All clients have strong tier 1 accounts, but clients need a healthy mix of tier 2 and tier 3 accounts to sell client products as well, so as to maintain margins of client products being sold, according to an exemplary embodiment.

Conventionally, it has been is difficult to gauge a level of effort that accounts are making in marketing a client's products, according to an exemplary embodiment. In many cases the only information that a client may use to gauge effort has been to determine effort based on sales volume, according to an exemplary embodiment.

By using the MAP policy management system, according to an exemplary embodiment, a client may be able to measure the level of effort that client accounts are making in marketing client products, so the client can easily understand if the account is trying to grow their business with the client, according to an exemplary embodiment.

### Target the “Right” new Internet Accounts

With the MySamm.net Prospect Manager, according to an exemplary embodiment, clients may identify new prospect accounts, by identifying those accounts making an investment in SEO and Product Level search term marketing effort, as evidenced by effort 206a, 208a and/or ranking columns 206b, 208b. If already an identified account, the account should appear on matched accounts 202, according to an exemplary embodiment. If an unmatched account, it may appear on unmatched accounts 902, according to an exemplary embodiment, discussed below with reference to FIG. 9, according to an exemplary embodiment.

The exemplary MAP policy management system identifies those prospects who are winning online in a client's product categories. So a client may make the right partner account choices and does not waste resources and time on less desirable prospects.

### Exemplary System Set Up Time

The MAP policy management system, according to an exemplary embodiment needs to be custom tailored to be tuned specifically as a solution to the needs of a client's business, according to an exemplary embodiment. It may be estimated, that, according to an exemplary embodiment, it may take up to 8 weeks (it may take less time) to configure the various software crawlers and to set up of the specific system for a client, according to an exemplary embodiment. The timeline may depend on a total number of client products offered and the number of accounts that are going to be tracked, according to an exemplary embodiment.

How does the MAP Policy Management System Work within a Client's MAPP?

The MAP policy management system, according to an exemplary embodiment, may help a client to implement the MAP policy that the client has developed. Specifically, the client can create, e.g., but not limited to, exemplary email templates that may explain the policy created, according to an exemplary embodiment. The MAP policy management system does not offer legal advice; the system merely facilitates, according to an exemplary embodiment, the MAP policies that a client has previously created, according to an exemplary embodiment.

### What May be Sent to Accounts Breaking MAPP?

The MAP policy management system may offer customizable templates that a client can tailor to the client's specific needs, according to an exemplary embodiment. With each communication template, the MAP policy service may allow a client to include documentary evidence of the client products breaking MAPP, according to an exemplary embodiment. Specifically, the client can send the following, according to an exemplary embodiment: a client product SKU of a client product being advertised by an account, including breaking MAPP, an client product MAP price, an account's advertised price for the client product, an image, or other content, where an exemplary embodiment of the MAPP management system found the advertising of the client product breaking MAPP, and/or, a link such as, e.g., to content of the account, such as, e.g., the URL, etc., of a webpage, etc.

How Frequently does the Client Receive Data from the Crawlers?

A client can schedule the crawlers to run at exemplary, scheduled intervals (e.g., 2, 3, or 4 week intervals, or shorter or longer, etc.), according to an exemplary embodiment. The amount of times a client may “cycle” the crawlers may depend on specific client needs and can affect a client's monthly costs. It is recommended that the crawlers should run at least 1 time per month, according to an exemplary embodiment. During times a client is not running the crawlers, a client may be managing the accounts identified, according to an exemplary embodiment, breaking the client's MAP policy. Managing MAPP, according to an exemplary embodiment, may include, among other things, sending emails and/or other communications to an account, and/or tracking a history of the MAPP breaks, according to an exemplary embodiment.

Can a Client Determine when the Crawlers Run?

The MAP policy management system, according to an exemplary embodiment, may include a software based crawler, which may include an exemplary scheduling component, in an exemplary embodiment, so the client's, e.g., but not limited to, can run the crawlers over a weekend to identify accounts lowering prices on weekends when a client is not working, according to an exemplary embodiment.

What does it Cost?

The monthly maintenance costs for an exemplary system, according to an exemplary embodiment, may vary based on the number of client products, that the client wishes to manage and the number of websites needing to be analyzed, according to an exemplary embodiment. A client may also have an initial upfront cost required for the set up, configuration and server balancing of the system, according to an exemplary embodiment.

Are there Limitations to the Number of Products and Accounts I can have Managed?

According to an exemplary embodiment, there is not a limit to a number of accounts, however, a cost will be higher based on the number of accounts and client products a client wishes to track. The greater the number of client products and accounts, according to an exemplary embodiment, the more data the MAP policy management crawlers need to find, according to an exemplary embodiment.

### Managing Internet Accounts

### Exemplary Notes & Definitions:

1) The term “client” herein refers to, e.g., but not limited to, a manufacturer, importer and/or wholesaler of goods who sells their “client product” goods to accounts, according to an exemplary embodiment.

2) The term “account” herein refers to an exemplary website or ecommerce company advertising for sale the goods of the client as defined above in (1) above, according to an exemplary embodiment. The accounts may also advertise the price of these client product goods, according to an exemplary embodiment.

3) The term “crawl” herein refers to the event of gathering data from a website.

Gathering of data may be performed in various well known matters by, e.g., but not limited to, an electronic software agent, referred to as a spider, and/or crawler, which may access and analyze various websites, to gather desired information, and to detect and capture related data, according to an exemplary embodiment.

4) The term “MAP” or “MAPP” refers to the minimum advertised price (MAP) that the client has set for a specific product, as part of its MAP policy (MAPP), according to an exemplary embodiment.

5) The term “unauthorized accounts” refers to “unmatched accounts” (a current client advertising for sale client's products under, e.g., but not limited to, an unknown ecommerce site, etc.) or an unauthorized entity advertising for sale the client product that does not have client's permission to sell its products, according to an exemplary embodiment.

6) The term “unauthorized entity” herein is sometimes referred to as a “rogue account” but should be more accurately labeled as a “rogue entity” as the unauthorized entity is not actually a client account with permission to sell its products, according to an exemplary embodiment.

An exemplary mySamm.net MAP policy management service, according to an exemplary embodiment of the present invention, may include an application, or application program, or applet, which may be provided on various computing platforms, which may enable a client business to manage its MAP policy by in an automated fashion analyze accounts and identify those accounts breaking MAPP, according to an exemplary embodiment.

According to an exemplary embodiment, clients may manage their MAP policy using a user-friendly, management system, which collects, analyzes, formats and presents in easy to read tables, and graphs, instances of when an account is breaking MAP for a client's products. The exemplary MAP policy management system may be developed using, e.g., but not limited to, an extensible programming environment, to ensure easy access running on any of various client user computing platforms, according to an exemplary embodiment. The MAP policy management application may include an exemplary system, method, and/or computer program product, according to an exemplary embodiment, which may include a graphical user interface, which may be interactively used on any of various electronic devices of the client (e.g., but not limited to, a laptop, a personal computer, a terminal, a mobile device, smartphone, cellular phone, an iPod, an iPod Touch, an iPhone, an Android device, a Mac, a PC, a tablet, an iPad, a smart television, a smart device, a smart car, a smart appliance, a notebook, a computer, a communications device, a mobile phone w/text, a smartphone, a personal digital assistant (PDA), a mobile phone, an Internet browser application, a standalone application, a set top box, a television receiver, a smart television, and/or any of various exemplary but not limiting devices, etc.) and may allow interactive access to, and management of the MAP policy between the client and its various online accounts, according to an exemplary embodiment.

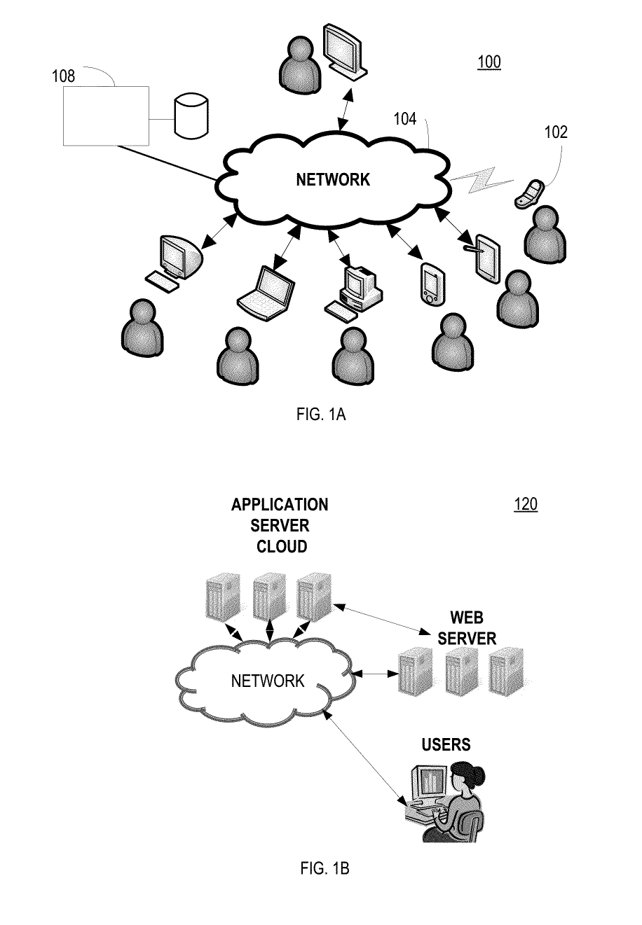

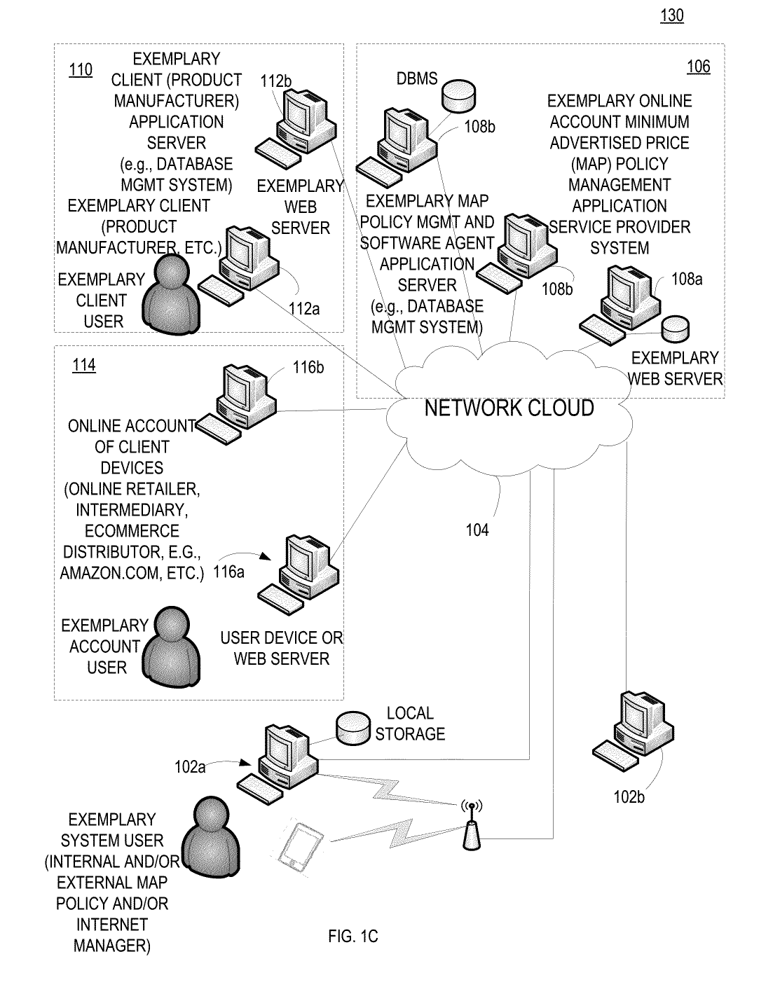

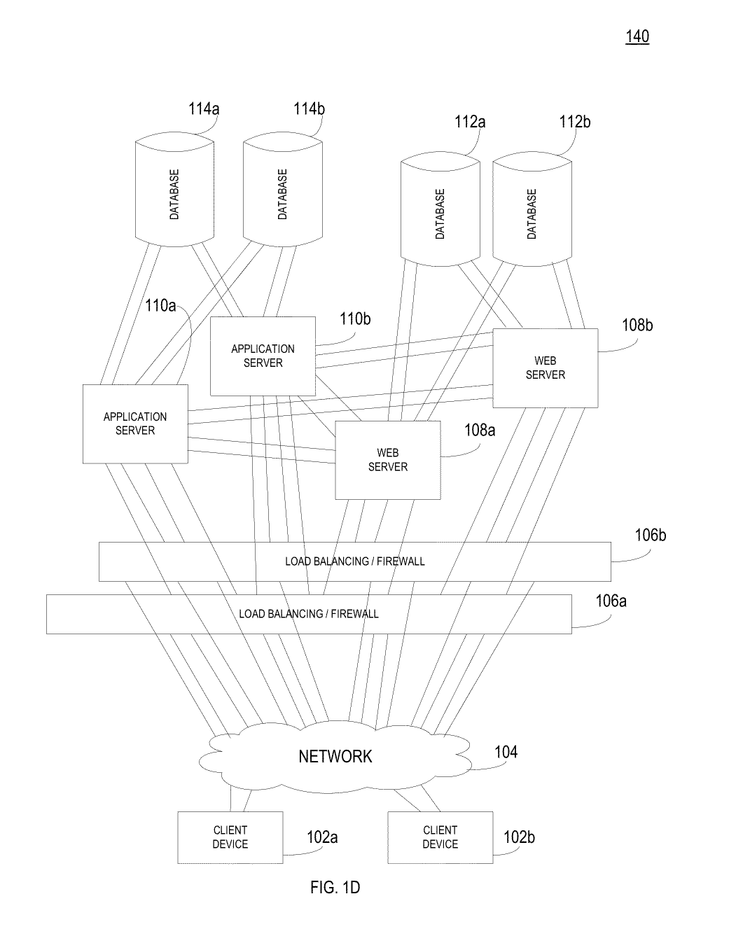

FIG. 1A depicts an exemplary view of an exemplary embodiment of an exemplary heterogeneous client device environment coupled to an exemplary network system capable of delivering online electronic commerce sales to various users, and adapted, according to an exemplary embodiment, to provide a client online account minimum advertised price (MAP) policy management application system, method and computer program product, hardware application system architecture environment, including an exemplary plurality of client 102 and/or server 108 computing and/or communication devices coupled together in a distributed networked system architecture 100, according to an exemplary embodiment.

The distributed networked system architecture 100 may include an exemplary computer system platform 108 executing an exemplary software application program, which may reside, in an exemplary embodiment, on an exemplary user's client computing and/or communications device 102, and/or on a server 108 in interactive communication over an exemplary network 104 with the user's client computing device 102 in a client/server, hierarchical, terminal server, or peer-to-peer fashion, may include, but is not limited to, a computing or communications device, desktop/laptop computers, tablet computers, personal digital assistant, telephony, smart-phone, mobile device, mobile phone, wireless device, tablet, personal digital assistant, handheld and the like, which may in an exemplary embodiment, be the device capable of providing user display or other output and receiving input from user interactive selections via any of various well known input devices, for managing online MAP policy and for facilitating crawling of online ecommerce systems advertising client products, and for tracking MAP breaks, as well as for facilitating issuing notifications to accounts breaking MAP policy with their advertising, etc., by providing users various MAP policy management tools, accessible in various ways via any of a range of user computing and/or communications devices, according to an exemplary embodiment. According to an exemplary embodiment, various versions of the exemplary software program, which may be a software application program, a cloud-based application, a client-server application, an applet, an app, an iOS app, an Android app, a Windows 7/8/n+ app, a standalone application program, a browser-based user interface application, an Internet-browser-based interface, a Java application or applet, among various other exemplary embodiments, as will be apparent to those skilled in the art, and as discussed further below with reference to FIGS. 1A-5, according to various exemplary embodiments.

In an exemplary embodiment, exemplary screen shots may illustrate exemplary, but not limiting, browser-based, web-based, graphical user interface (GUI) based, and/or other user interactive interfaces, but may also take other forms of applications or applets, such as, e.g., but not limited to, a toolbar, a standalone application, networked application, a mobile device application, and/or a browser-based toolbar, etc. In another exemplary embodiment, the application may be an applet, or other application program that may be provided in any of various well known ways, such as, e.g., but not limited to, an Internet browser-based toolbar, a JAVA applet, an ANDROID application, a Windows 7 or Windows 8, etc. application program, an iPOD, iPhone, or iPAD application, a MAC OS/X application, an iOS application, or the like, etc., according to an exemplary embodiment.

FIG. 1B depicts an exemplary embodiment of a network-based MAP policy management system, system architecture high level diagram 120, according to an exemplary embodiment, which may be coupled together by an exemplary cloud-based architecture network, according to an exemplary embodiment.

According to an exemplary embodiment an exemplary cloud and/or network system and software, or a local/remote client/server topology, a world wide web based (WWW) internet browser based application, or the like application may be provided, according to an exemplary embodiment. Users as shown in diagram 120 may access applications, in an exemplary embodiment via a network illustrated by the cloud, which may include, for example web servers such as, e.g., but not limited to, domain name servers (DNS) servers capable of domain name resolution, and hyper text markup language (HTML), JAVA applications, and/or extensible markup language (XML) implemented interactive applications, as a service offering may be implemented, and may allow, e.g., but not limited to, interactive client to remote server device interaction in well known matters via various well known network protocols such as the internet protocol (IP) and the transmission control protocol (TCP), etc., as well as, or alternatively, any other well known network stack implementing the various communications layers of the OSI model for standard communication between two or more computing devices, according to an exemplary embodiment. According to an exemplary embodiment, many exemplary commercial cloud service providers may be used to host an application, if not a separate server one may use a cloud based offering such as, e.g., but not limited to, Amazon, Rackspace, Microsoft and/or many others as will be apparent to those skilled in the art, offering such capabilities, or alternatively application service providers (ASPs), software as a service (SAAS) providers, etc., according to an exemplary embodiment.

FIG. 1C depicts an exemplary embodiment of an exemplary system architecture diagram 130 illustrating an exemplary distributed user and exemplary minimum advertised price (MAP) policy management service provider 106 network 104 environment, exemplary manufacturer client application server 110, and exemplary online account 114 advertiser (and/or marketer) of the client products of the client, according to an exemplary embodiment. According to one exemplary embodiment, various applications may be shown as appearing as being stored in, and/or executed on one and/or more example systems, however, various alternative exemplary embodiments may also be used where some portions of data and/or applications may be stored in and/or executed on, one system, and other portions of data and/or applications may be stored in, and/or executed on, another system and/or additional multiple systems, local, and/or remote to, any of the given systems. Similarly, where data and/or programs are shown as executing on separate computing devices in exemplary embodiments, in alternative exemplary embodiments, such separate systems may be stored and/or executed on a single system, and thus reference to “at least one processor” should be understood to refer to one and/or more separate computing device systems, and/or a single system having one and/or more processor devices within it, etc., according to an exemplary embodiment.

FIG. 1C depicts an exemplary embodiment of an exemplary system 130 illustrating an exemplary distributed network environment, according to an exemplary embodiment. Diagram 130 of FIG. 1C illustrates an exemplary system user device 102a, 102b, collectively referred to as 102, such as including, e.g., but not limited to, a personal computer (PC), computing device, communications device, and/or smartphone, etc., (among other devices as illustrated in FIG. 1A above, etc.) by which a user may access a network 104 to gain access to other network resources, including the MAP policy management service provider 106 application system, according to an exemplary embodiment. According to an exemplary embodiment, the user device 102 may communicate via network 104 to other user devices 102 via any of various communications applications such as, e.g., but not limited to, electronic mail systems, social networks, and/or online connections such as a transport control protocol (TCP), etc., to other network accessible devices such as, e.g., but not limited to device 106, 110, 114, or peer device 102b, according to an exemplary embodiment.

As illustrated, system 130 may include an exemplary online account minimum advertised price (MAP) policy management system 106, which may be used to manage online accounts of an exemplary client 110 (such as, e.g., but not limited to, a manufacturer), where the online account 114, may be, e.g., a company, etc., which may be advertising and selling, online, the client's products, referred to herein as client products, to final customer/consumers of the client and online account, according to an exemplary embodiment. The MAP policy management service provider system computer platform 106 may include, e.g., but may not be limited to, one or more exemplary web server(s) 108a, one or more application server systems 108b, which may include any of various additional software application subsystems including, e.g., a database management system (DBMS), etc., among others, according to an exemplary embodiment. The MAP policy management service 106 may be a third party to, or may be part of or captive to an exemplary client manufacturer system 110, according to an exemplary embodiment.

An exemplary client manufacturer may include any of various product manufacturer(s) who may market (i.e., including advertising and/or selling) product(s) referred to as client products through any of various distribution channel(s) and/or marketing channel(s). According to an exemplary embodiment, the exemplary client 110 may be part of, or separate from the MAP policy management service 106, and may include various exemplary devices, according to an exemplary embodiment, including one or more exemplary web server(s) 112a, and/or exemplary application servers 112b, according to an exemplary embodiment. The client may include one or more exemplary client users, who may separately access one or more of the exemplary application system(s) and/or web server(s), to, e.g., but not limited to, review results of various processing, manage policies, facilitate sending notifications to accounts, etc., by interactively accessing via one or more user devices such as, e.g., but not limited, user device(s) 102a, 102b, etc., according to an exemplary embodiment.

According to an exemplary embodiment, client 110 may have any of various online accounts 114, which may market, advertise and/or sell client products, e.g., manufactured or distributed by the client 110. In an exemplary embodiment the account(s) 114 may have various users, which may access the greater system 130, via, e.g., but not limited to, a user device 102a, 102b, not shown, and may, e.g., receive notifications from the MAP policy service provider system, according to an exemplary embodiment. The online account 114 may itself include one or more user device(s), web server(s) 116a and/or application server(s) 116b, etc., according to an exemplary embodiment, and/or may user portions of another company's computing and/or networking devices, according to an exemplary embodiment. The marketing, advertising, and sales by the online account are provided, according to an exemplary embodiment, online, and thus advertising is electronically accessible, according to an exemplary embodiment. The online account may include an online retailer, an online intermediary, an online distributor, an ecommerce distributor, an online marketing and/or sales agent, etc., according to an exemplary embodiment. According to an exemplary embodiment, the online account may include an entity marketing and/or advertising client products on its own devices, and/or on another entity's hosted devices, such as, e.g., but not limited to, marketing via an online ecommerce marketer and/or distributor such as, e.g., but not limited to, Amazon.com, etc., and/or via an online advertising service provider such as, e.g., but not limited to, Google.com, etc.

FIG. 1D depicts an exemplary embodiment of diagram 140 of an exemplary system illustrating an exemplary network 104 environment, with exemplary load balancing 106 and exemplary meshed fault tolerance, which may be used to couple exemplary user devices 102 to an exemplary MAP policy management service provider application server 110, and/or web servers 108, and/or databases 112, 114, according to an exemplary embodiment. FIG. 1D illustrates an exemplary overview of an exemplary system as may be used in an exemplary environment according to various exemplary embodiments of the present invention. FIG. 1D depicts an exemplary embodiment of a high level system block diagram 140 that can be used to provide an exemplary system for providing an exemplary MAP policy management service provider system, according to an exemplary embodiment of the present invention. According to one exemplary embodiment, various applications may be shown as appearing as being stored in, and/or executed on one and/or more example systems, however, various alternative exemplary embodiments may also be used where some portions of data and/or applications may be stored in, and/or executed on, one system, and/or other portions of data and/or applications may be stored in, and/or executed on, another system and/or additional multiple systems, local, and/or remote to, any of the given systems, etc. Similarly, where data and/or programs are shown as executing on separate computing devices in exemplary embodiments, in alternative exemplary embodiments, such separate systems may be stored and/or executed on a single system, and thus reference to “at least one processor” should be understood to refer to one and/or more separate computing device systems, and/or a single system having one and/or more processor devices within it, etc., according to an exemplary embodiment.

The high level system block diagram 140 of FIG. 1D may include, in an exemplary embodiment, users interacting with exemplary browsers and/or applications running and/or accessible, on exemplary client devices 102a, or 102b (collectively 102), respectively, according to an exemplary embodiment. An exemplary user interface and/or browser can be, e.g., but not limited to, an application software programs executing on one or more computer workstations and/or other computer processor based devices 102 (including exemplary devices such as, e.g., but not limited to, computing devices, communication devices, mobile devices, phones, mobile phones, smartphones, tablets, thin or fat clients, and/or computer tablets), which may be coupled via a network 104 (in exemplary wireline and/or wireless fashion) to other devices, as shown, in an exemplary embodiment. Workstations 102 can be coupled via an exemplary network 104 such as, e.g., but not limited to, an internet, an intranet, a private and/or public network, and/or another type of network, etc., according to an exemplary embodiment. In an exemplary embodiment network 104 may include the global Internet, according to an exemplary embodiment. Network 104 may provide access for exemplary workstations or as labeled exemplary client devices 102 to gain access to, e.g., but not limited to, one or more application servers 110a, 110b (collectively 110), such as, e.g., but not limited to, an exemplary database management system (DBMS) (not shown), according to an exemplary embodiment. Although a client server topology is discussed, any of various other well-known types of communications topologies may also be used such as, e.g., but not limited to, point-to-point, peer-to-peer, cloud-based, application service provider (ASP), software as a service (SAAS), browser-based, hierarchical, distributed, and/or centralized, etc., according to an exemplary embodiment. The exemplary application server 110 can manage one or more databases 114a, 114b (collectively 114), according to an exemplary embodiment. In an exemplary embodiment, the application server 110 can access an exemplary database(s) 114 having a plurality of data records, where in an exemplary embodiment, each data record may have one or more fields, etc., according to an exemplary embodiment. It will be apparent to those skilled in the art, that each database 112, 114 can be part of a larger database, or could be broken into a plurality of separate subdatabases, according to an exemplary embodiment. In an exemplary embodiment of the present invention, access to the application executing on application servers 110 may also be accessed via one or more web servers 108, and/or other databases 112a, 112b (collectively 112), according to an exemplary embodiment. Further, queries and/or interactive requests from devices 102 may be routed over network 104, and over one or more load balancers and/or firewalls 106 to query the databases 112, 114, and query results and/or search results can include, e.g., but not limited to, one or more of a plurality of fields and/or one or more of a plurality of records obtained from the database(s) 112, 114 that meet search criteria included in query and/or search query, according to an exemplary embodiment. Network 104 may be coupled to any of various well known components such as, e.g., but not limited to, one or more load balancing devices or firewall devices 106a, 106b (collectively 106), web server(s) 108, application server(s) 110, routers, gateways, bridges, physical layer devices, data link layer devices, transport layer devices, and/or network layer devices, etc., according to an exemplary embodiment.

As illustrated, web servers 108 and application servers 110 may be coupled to one another via one or more network(s) 104, according to an exemplary embodiment. In an exemplary embodiment, the servers may be meshed to provide a level of fault tolerance and backup in the event of failures, according to an exemplary embodiment. Although exemplary network 104 is shown, in an exemplary embodiment, as being downstream of load balancing devices 106, it is also possible to have a network upstream of load balancing devices 104, coupling, e.g., but not limited to, application server(s) 110, web server(s) 108, and/or database(s) 112, 114, as well as other client or other server devices (not shown), local and/or remote from the depicted exemplary devices, etc., according to an exemplary embodiment. Exemplary client devices 102 are depicted in an exemplary architecture topology positioned downstream over an exemplary network(s) 104 from the server devices, but could easily be elsewhere in the network topology, e.g., inside, or outside a firewall. It is also important to note that network 104 is represented in an exemplary cloud metaphor schematic, but various well known network devices including various well-known star-based, star-wired ring-based, bus-based, and/or other well known network topologies may also be represented by exemplary network(s) 104, according to an exemplary embodiment.

A user interacting with an exemplary application interface and/or browser on workstation 102a can access, e.g., but not limited to, the database 114a, in an exemplary embodiment by traversing several intervening networks using well known communications protocols such as, e.g., but not limited to, transmission control protocol/internet protocol (TCP/IP). Specifically, in an exemplary embodiment, the workstation 102a can be coupled via exemplary network(s) 104 including, e.g., but not limited to, a public and/or private network, and/or the global Internet to any of various exemplary website system(s), in this exemplary case, web server(s) 108a, 108b (collectively 108), which may include any of various hosting systems such as, e.g., but not limited to, a domain system, a domain name server (DNS), a domain controller system, etc., according to an exemplary embodiment. Website or webserver system 108 in an exemplary embodiment can be, an exemplary mySamm.net Service Provider website available from mySamm (mySamm.net) available from LJ&L Enterprises, LLC of Alexandria, Va. USA. The website system 110 can include, in an exemplary embodiment, an exemplary firewall 106 coupled to, or in addition to, or integrated with, a load balancer 106a, 106b (which could alternatively run on a general purpose computer such as, e.g., web server 108a, 108b, etc. Load balancer 106 can be coupled to an exemplary web server 108a, and 108b, according to an exemplary embodiment. Web servers 108a, 108b can be mesh coupled to one or more application servers 110a, 110b, via exemplary hardware and/or software system solutions, according to an exemplary embodiment, or via another network 104 (not shown), according to an exemplary embodiment. Each server 108, 110, may include, e.g., but not limited to, or be coupled to, one or more database(s) 112, 114, according to an exemplary embodiment. Web server(s) 108a, 108b in an exemplary embodiment, can perform exemplary load balancing and/or exemplary firewall functions by transferring user application requests/queries to one or more of the application servers 110a, 110b, according to an exemplary embodiment. Results of the exemplary requests and/or queries from database 114 can be transferred from application servers 110a, 110b through web servers 108a, 108b through the network 104 to workstation or client device 104, according to an exemplary embodiment. For example, according to an exemplary embodiment, the MAP policy management application server 110 of FIG. 1D, or 106 of FIG. 1C, the service provider system may assist the MAP management service provider's clients needs to manage their Minimum Advertised Price policies (MAP or MAPP) with ecommerce accounts, by providing an interactive exemplary client-server application mySamm.net, a software tool operative to track and automate MAP policy management, according to an exemplary embodiment, as well as provide other business intelligence tools, in an exemplary embodiment, available from LJ&L Enterprises, LLC and Strategic Advance.

The exemplary MAP policy management application program and/or links, may be further integrated with and/or embedded into other well known collaborative, and/or social networking environments or applications such as, e.g., but not limited to, Facebook, LinkedIn, LotusLive, Microsoft Exchange/Sharepoint, GoogleTalk, GoogleVoice, Skype, Facetime, Google+, and/or video teleconferencing, Voxeo, SalesForce.com, CRM systems, etc., and/or other network environments, social media environments, communications environments, and/or collaborative environments, according to various exemplary embodiments.

Any illustration of exemplary fixed images, and/or exemplary arrangements of the exemplary application user interface are intended to be merely exemplary, and nonlimiting, as video means, audio means, and/or a combination of audio/video streams and/or other forms of interactive information access, delivery and/or content provision, may also be used to enable efficient user interaction, according to various exemplary embodiments.

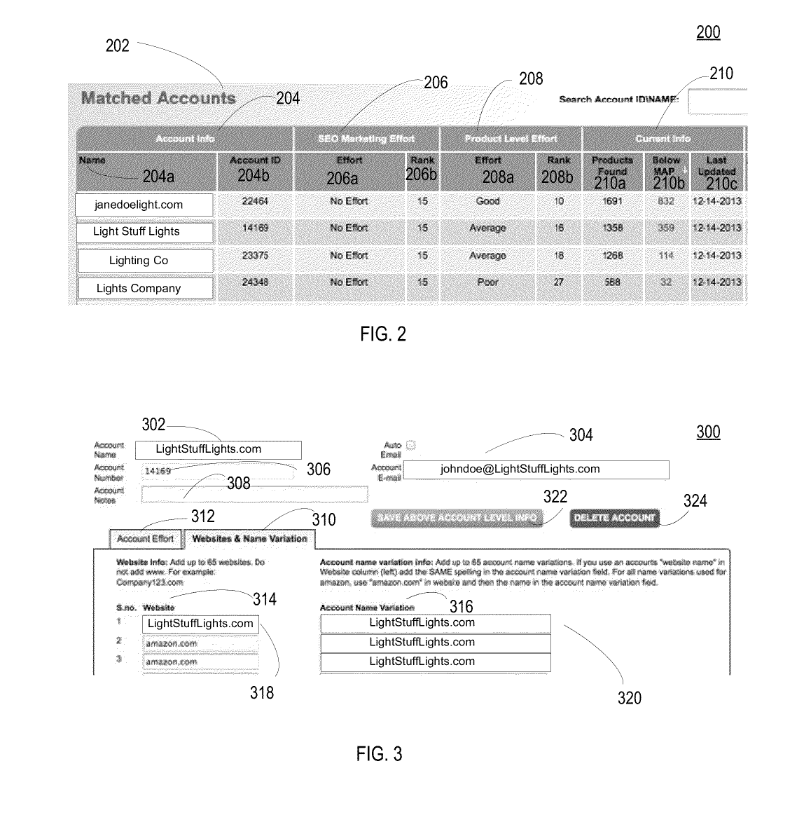

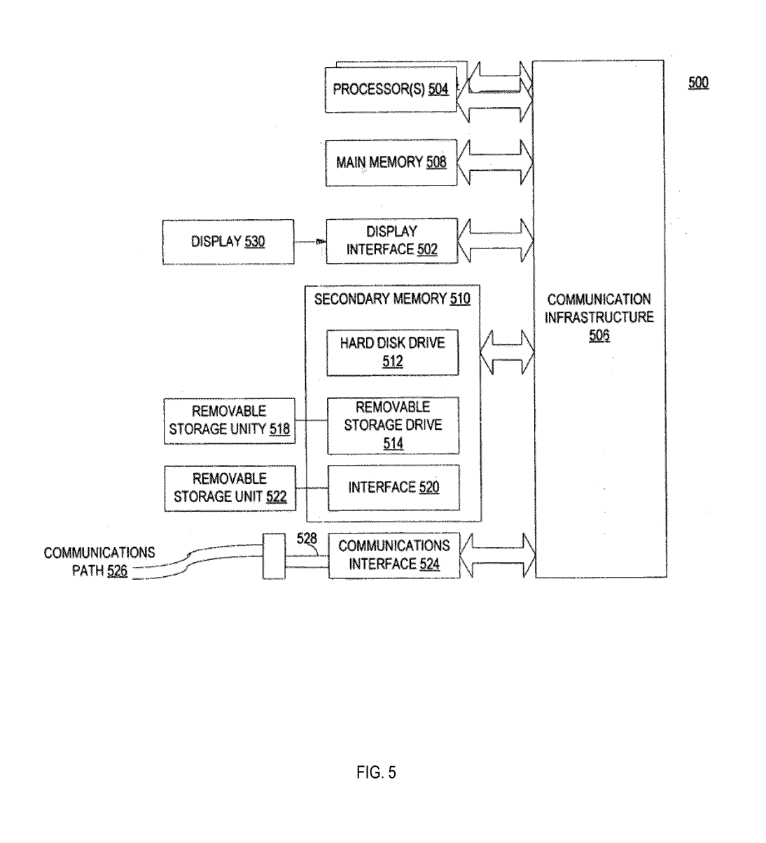

FIG. 5, described further below (after the description of FIGS. 2-25) provides an exemplary hardware platform architecture for an exemplary computing device system as may be used for any of the various exemplary devices illustrated in the above diagrams of FIGS. 1A-1D, according to an exemplary embodiment.

The FIG. 2 depicts an exemplary screenshot image 200 representing an exemplary list of accounts for an exemplary client. In the image, the “Products Found” column 210a, is an example illustrating presenting information of products found, and “Below MAP” column 210b illustrates products found below MAP, according to an exemplary embodiment.

FIG. 2 depicts an exemplary embodiment of an exemplary screenshot of an exemplary user interface (UI) 200 illustrating an exemplary MAP policy management application program for managing an exemplary client's MAP policies with respect to the client's products marketed in advertising by one or more client accounts, according to one exemplary embodiment. FIG. 2, specifically, depicts an exemplary embodiment of a diagram 200 illustrating an exemplary portion of an exemplary graphical user interface (GUI) exemplary partial screenshot 200 depicting an exemplary user interface of an exemplary Matched Accounts 202 listing screen of an exemplary user view of a client's matched accounts, according to an exemplary embodiment. It is important to note that various exemplary embodiments, including one or more exemplary optional features for an exemplary MAP policy management application may be depicted, but such exemplary features, need not necessarily be included in all embodiments. For example, diagram 200 may illustrate inclusion of an interactive user interface as may include one or more columns and/or rows, as well as exemplary column headings and/or exemplary hyperlinks 202-210, according to an exemplary embodiment. As shown, matched accounts partial screenshot 200 may include an exemplary matched accounts 202 title, and an exemplary “Search Account ID/NAME:” field (not labeled), where a user of an example client may search for a particular account by an exemplary account identifier (ID), and/or by Account Name. The exemplary table of the exemplary matched accounts 200 screenshot may include various exemplary columns, including, e.g., but not limited to, account information (Info) 204, search engine optimization (SEO) marketing effort 206, product level effort 208, and current information (Info) 210, according to an exemplary embodiment. The exemplary columns 204, 206, 208, 210, may each include various exemplary subcolumns including, e.g., but not limited to, for the exemplary subaccount information (Info) 204, may include, e.g., but not limited to, an exemplary name 204a (e.g., exemplary account name, and/or Internet domain name of the account, and/or universal resource locator (URL) of the account, etc.), and/or an exemplary account identifier 204b column (e.g., an exemplary account identifier, number, etc. identifying uniquely, the account of the client); for exemplary search engine optimization (SEO) marketing effort 206, may include, e.g., but not limited to, an exemplary effort column 206a, and/or an exemplary rank 206b column; for exemplary product level effort 208, may include, e.g., but not limited to, an exemplary effort column 208a, and/or an exemplary rank 208b column; and exemplary current information (Info) 210, may include, e.g., but not limited to, an exemplary products found column 210a, below minimum advertised price (MAP) column 210b, and/or an exemplary last updated 210c column, according to an exemplary embodiment.

The exemplary Matched Accounts 200 interface page or screen may include, in an exemplary embodiment, an exemplary list of a Client's Accounts in column 204a (e.g., jane doe light, light stuff lights, lighting co, and lights company (all fictitious exemplary accounts), listing for each the SEO Marketing effort 206 being expended by each account, which may include an exemplary effort indication, in the form of quantitative and/or qualitative effort data 206a, and/or ranking information 206b, which may include an exemplary numerical ranking, according to an exemplary embodiment. In an exemplary embodiment, the SEO marketing effort may be rated in a range, and may be a relative indication, as compared to other accounts, for example, according to an exemplary embodiment.

The exemplary Matched Accounts 200 interface page or screen may further include, in an exemplary embodiment, an exemplary list of a Client's Accounts, listing for each the Product Level Marketing effort 208 being expended by each account, which may include an exemplary effort indication, in the form of quantitative and/or qualitative effort data 206a, and/or ranking information 206b, which may include an exemplary numerical ranking, according to an exemplary embodiment. In an exemplary embodiment, the product level marketing effort may include a rating, relative grouping, and/or a range, and may be assigned an exemplary numerical value, and/or may have a relative indication, as compared to other accounts, for example, according to an exemplary embodiment.

The exemplary environment may accommodate an exemplary consistent user experience across an exemplary multiple platforms, permitting a user to access the MAP policy management application on any of various computing devices such as, e.g., but not limited to, a notebook computer, a handheld, and/or smartphone device, and/or via a browser-based Internet terminal, and/or via an applet based, and/or cloud-based and/or application service provider (ASP) based solution, and/or standalone computer applet based system, etc., according to an exemplary embodiment.

According to one exemplary embodiment, an exemplary MAP policy management application program and/or links to the portal, may be integrated into and/or embedded other well known collaborative environments and/or social media applications such as, e.g., but not limited to, LotusLive, Microsoft Exchange/Sharepoint, GoogleTalk, GoogleVoice, Skype, Facetime, Google+, Facebook, and/or video teleconferencing, Voxeo, SalesForce.com, CRM systems, etc., and/or other network environments, social media environments, communications environments, and/or collaborative environments. Thus, any illustrations of exemplary tables, exemplary fixed images, and/or exemplary arrangements of the exemplary user interface portal is merely exemplary, but nonlimiting as alternative user interfaces, providing graphical charts, and/or other indications of data, rather than purely numeric, or by qualitative textual definition (good, average, poor, no effort, etc.), including, e.g., video means, audio means, an audio and/or a video stream and/or other content may also be used to provide and/or list data information collected to be used to manage MAP policy management, according to various exemplary embodiments.

FIG. 3 depicts an exemplary embodiment of an exemplary screenshot of an exemplary user interface (UI) 300, illustrating an exemplary MAP Management application's account information record, for an exemplary light stuff lights account (fictitious) including various exemplary fields, according to an exemplary embodiment.

FIG. 3 depicts an exemplary embodiment of a diagram 300 illustrating an exemplary user interface screenshot for an exemplary embodiment of an application representing receiving of client's account information (i.e., information regarding the name of an account (fictitious) named Light Stuff Lights' advertising one or more of the client's products and/or the actual account websites that are advertising for sale client products on the Internet, according to an exemplary embodiment. Diagram 300 depicts an exemplary portion of an exemplary screenshot illustrating various exemplary information for the account “lightstufflights.com” that has been provided by an exemplary client, e.g., but not limited to, an exemplary lighting manufacturer, including various information about the account, including, e.g., but not limited to, an account name 302, an email address 304, a box tracking whether to send an automated email or other notification and/or communication, an account number 306, a field for taking account notes 308, an account effort tab 312, and a visible website and name variation tab 310, including a list of related websites 314, such as example lightingbygregory.com 318, and an associated account name variation 316, namely lighstufflights.com 320, according to an exemplary embodiment. The user from the client may enter additional account information and/or notes, etc. into the various fields, and may then use a user interface button/element save above account level info 322, or if deletion of the account is desired, may delete using interface element 324, according to an exemplary embodiment.

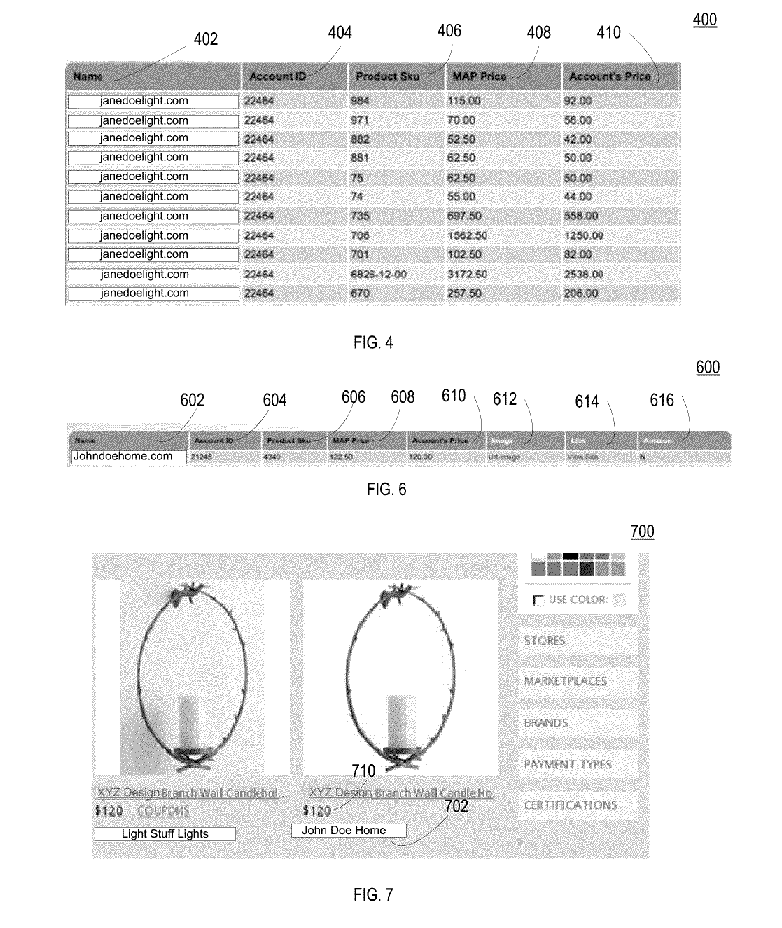

FIG. 4 depicts an exemplary portion of an exemplary screenshot image 400, illustrating an example of an account Jane Doe Light (fictitious) and the account's MAP break information, in tabular form, (illustrating an example of determining which products are advertised below MAP, determined by comparing the product level information gathered for each account against the product information provided by the client, finding which products are advertised below the MAP, finding the actual price of each client product being advertised below the MAP, associating the information found from the comparing, to the correct account based on the client's account information, and presenting the information found on products and pricing) listed for an exemplary specific account (e.g., janedoelight.com). FIG. 4 includes various exemplary columns including, exemplary name column 402, exemplary account identifier (ID) column 404, exemplary product SKU 406, exemplary minimum advertised price (MAP) price column 408, and finally, exemplary Account's actual price 410, as recorded by the exemplary MAP policy management system, according to an exemplary embodiment.

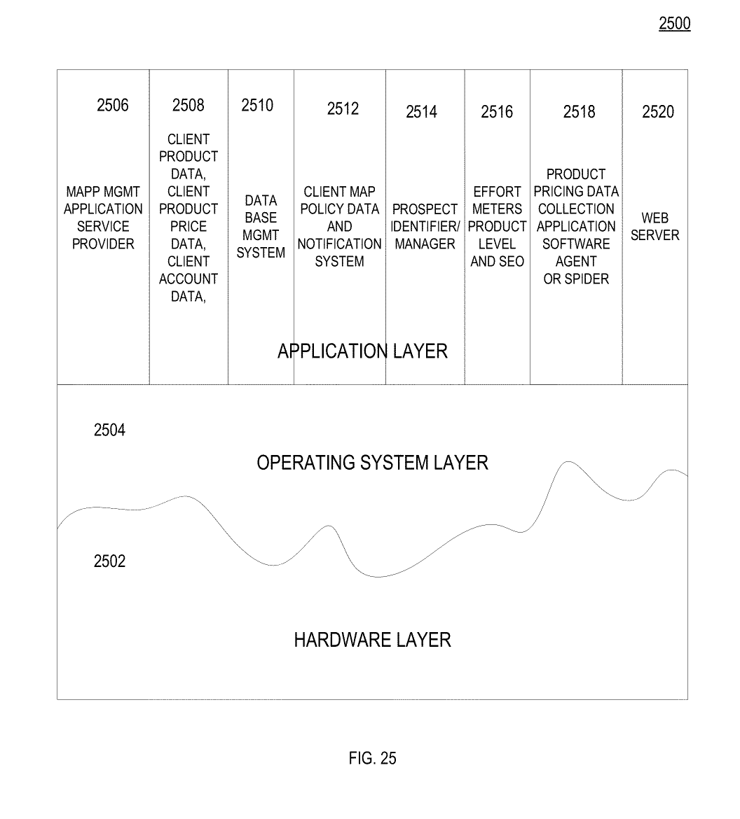

FIG. 5 depicts an exemplary computing device and/or system as may be used in various systems and/or devices, according to an exemplary embodiment as discussed further appearing below after the description of FIG. 25.

FIG. 6 depicts an exemplary image illustrating an example of a record capturing an instance of an actual MAP break of an exemplary account John Doe Home (johndoehome.com) (fictitious), as further illustrated below with reference to FIG. 7, according to an exemplary embodiment. FIG. 6 depicts an exemplary image screenshot illustrating an example of determining which products are advertised below MAP, according to an exemplary embodiment, determined by comparing the product level information gathered for each account against the product information provided by the client, finding which products are advertised below the MAP, finding the actual price of each client product being advertised below the MAP, and associating the information found from the comparing, to the correct account based on the client's account information, according to an exemplary embodiment. Also, in this illustrated image exemplary blue underlined hyperlinks 612, 614 show an example of a product listed below the MAP price 608 (a MAP break, i.e., an account's actual advertised price 610 of $120.00 below the MAP price 608 of $122.50), according to an exemplary embodiment. This image also conveys an illustration of capturing digital images of products being advertised below MAP, and associating (via a link to a universal resource locator (URL) 612, 614) of the digital images of the MAP break, and the actual site link (advantageously assisting in tracking where and what to do by the account to remedy the situation), along with the correct account, where the MAP break is properly associated with the johndoehome.com account, and the client product the product illustrated in the image of FIG. 7, according to an exemplary embodiment. Screenshot GUI 600 may include various columns including, e.g., but not limited to, an exemplary name column 602, an exemplary account identifier (ID) 604, a product stock keeping unit (SKU) 606 column including the client product number (i.e., a client product identifier may be simply a product SKU, an SKU keeps track of an identifies products in inventory), MAP price 608, account price 610, image 612, Link 614, and whether associated with Amazon column 616, according to an exemplary embodiment. FIG. 6 depicts an exemplary image screenshot 600 illustrating an example of determining which products are advertised below MAP, which may include comparing the product level information gathered for each account (such as exemplary account johndoehome.com) against the client product information, and may include finding which products are advertised below the MAP, finding the actual price of each product being advertised below the MAP, and/or associating the information found regarding the exemplary johndoehome.com account MAPP break with the correct account based on the client account information received. Also, in this image there are two (2) exemplary hyperlinks 612, 614, which show an example of a client product (product SKU 4340) advertised at account's price 610 of $120.00, which is below the MAP price 608 of $122.50 (i.e., a MAP break), according to an exemplary embodiment. This image also conveys an exemplary step where the MAP break may be properly associated with the exemplary johndoehome.com account, according to an exemplary embodiment.

FIG. 7 depicts an exemplary screenshot image 700 of an exemplary webpage (or portion thereof) captured of an exemplary MAPP break showing the client product (illustrated example candleholder) and actual pricing information 710 for the client product, as well as the exemplary client account name 702 (illustrated example John Doe Home) (fictitious), according to an exemplary embodiment. FIG. 7 depicts an exemplary image screenshot 700, or portion thereof, illustrating if the user client selects the “URL-Image” link 612 from screen 600 above, then the application may proceed to display an example of a saved “screen-shot” image 700, according to an exemplary embodiment. This image, according to an exemplary embodiment, may explain what may occur when, in capturing exemplary digital images (and/or other content) of client products being advertised below MAP, including an exemplary taking a digital image(s) of an exemplary screen shot(s) of at least a portion of a web page(s) advertising the exemplary client products below MAP. above where this account is advertising below MAP on product SKU 4340 of product SKU 606, according to an exemplary embodiment.

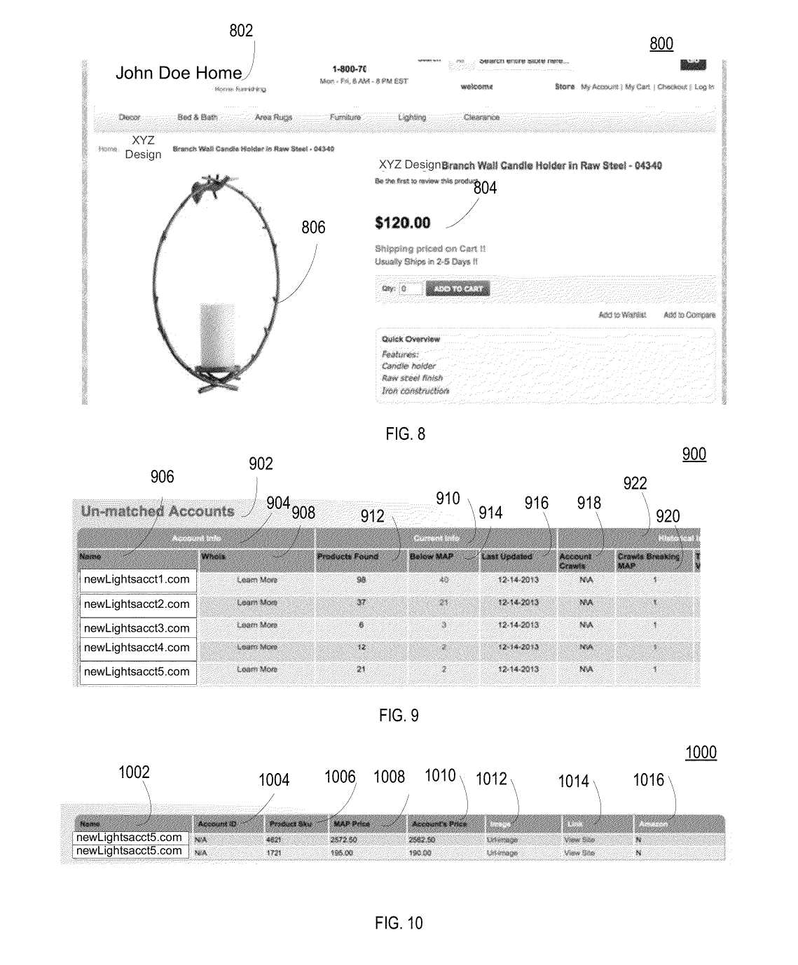

FIG. 8 depicts an exemplary image screenshot 800 illustrating capturing exemplary content of an exemplary account John Doe Home, such as, e.g., but not limited to, an exemplary at least a portion of, an exemplary webpage of a exemplary website, or other content of the account depicting the exemplary MAPP break, an example of capturing an exemplary universal resource locator (URL) of an actual account's exemplary webpage of an exemplary website, which is advertising for sale the client product, of the account John Doe Home (fictitious), which is advertising the client product below MAP. FIG. 8 includes an exemplary screenshot 800, which may include an exemplary webpage account name 802, one or more exemplary webpage content image(s) 806, and an actual account price advertised by the exemplary account of the client product, according to an exemplary embodiment.

FIG. 9 depicts an exemplary image screenshot 900 illustrating at least a portion of an exemplary screen of an exemplary user interface of the exemplary MAPP management system, providing an exemplary table of examples of un-matched accounts (illustrated as lightsacct1.com, lightsacct2.com, lightsacct3.com, lightsacct4.com, and/or lightsacct5.com) (all fictitious for the illustration) (which would have the actual name or domain name of the unmatched account name in the actual MAPP management system), each of which unmatched clients were found advertising a client product online, according to an exemplary embodiment. Exemplary screen 900 illustrates an exemplary embodiment of finding previously unknown accounts advertising client products, finding a total number of products a previously unknown account is advertising online, and finding previously unknown accounts advertising products below MAP, if any, according to an exemplary embodiment. According to an exemplary embodiment, screenshot 900 may illustrate an exemplary embodiment of a user interface screen 900, which may include an Unmatched Accounts 902 name, an exemplary account information column 904 (including an exemplary name column 906 for the unmatched account, and an exemplary whois column 908 including, e.g., a column of exemplary links to further information, such as, e.g., but not limited to, a whois domain name entry for the unmatched account, and or other information about each unmatched account); a current info column 910 (including an exemplary products found column 912, listing the number of client products of the client being advertised by the unmatched account, an exemplary below MAP column 914 providing an exemplary count of the number of client products falling below MAP, a last updated column 916, which may include a date of the last update to the unmatched account; and an exemplary historical column (not labeled partial right column), which may include a number of account crawls column 918, and a number of crawls breaking MAP column 920, according to an exemplary embodiment.

FIG. 10 depicts an exemplary image screenshot illustrating an exemplary screen 1000 of an exemplary user interface table, by which an exemplary user, such as, a client user, may view and interactively access exemplary MAPP break information, according to an exemplary embodiment, for an exemplary unmatched account newLightsacct5.com (fictitious), according to an exemplary embodiment. Exemplary screen 1000, may include, an account name column 1002, an account ID 1004 (if no account ID is listed, i.e., N/A, then the account has not yet been matched to a known account, and may be further operative to associate by client user matching and/or selection an exemplary unmatched account with a known account converting the unmatched account to a matched account, according to an exemplary embodiment), product SKU column 1006 may list the SKU of the client product being advertised by the account, MAP price column 1008 may list the MAP price for the client product being advertised by the account, and account's price column 1010 may list an actual unmatched account price for the client product being advertised by the unmatched account, image column 1012 may include a link 1012, which may provide access to a URL image of the MAP break, exemplary link column 1014 may include a link to the actual page of the account including the MAP break price, and Amazon column 1016 may note whether the account is an Amazon distributor, according to an exemplary embodiment. Thus, screen 1000 may include exemplary hyperlinks, which a client user may use by clicking either link to view an image 1012 taken of the MAP break, “URL-Image” link may allow access to allow the client user to view the exemplary image in column 1012 of the actual MAP break by the listed account in name 1002, and the link 1014 may provide a directly accessible link to access the website of the account advertising the client's product, according to an exemplary embodiment.

FIG. 11 depicts an exemplary image screenshot illustrating an exemplary screen 1100 including an exemplary image of a user interface of an exemplary MAPP break communication template of the exemplary MAP policy management application, showing an exemplary interface, which a client may use to interactively create, e.g., but not limited to, an exemplary fully client customizable template email(s), and/or other communication, notify an exemplary account of the client's MAP policy, however the client may wish, according to an exemplary embodiment. In the exemplary embodiment, various exemplary header fields 1102 may be populated and/or included such as, e.g., but not limited to, a title field, a subject field, a description field, and a from field, which would have the client email address for the originator of the exemplary email notification, a body field 1106 may include template body language for the email, helpful hints field 1104 may explain how to insert links, etc. Various placeholder terms are indicated on the exemplary template, and once the client has customized an exemplary email notification, as shown, a save as button 1108 allows the client to save the template, according to an exemplary embodiment. Screen 1100 illustrates an exemplary notification portion of the exemplary MAPP management system, which may be used in notifying an account of the account's MAP breaks, according to an exemplary embodiment. By providing an exemplary email template, the client can then customize the template based on the client's MAP policy, and may use the template to create exemplary emails (or other communications) to those by using the template may include creating a specific email with the client's customized template message, and customizing emails containing actual MAP break information for each account showing: the client product(s) account has listed below MAP, and the price of each client product the account is advertising below MAP, the correct MAP price the account should not be advertising below, a hyperlink to the actual web page, which was advertising the client product & the actual product price being advertised, and/or a hyperlink to a stored date-stamped digital Image (e.g., at least a portion of an exemplary screen shot) showing the client product being advertised at an actual price below MAP, according to an exemplary embodiment.

FIG. 12 depicts an exemplary image screenshot 1200 illustrating an exemplary screen including an exemplary image illustrating an exemplary tabular user interface displaying an exemplary list of accounts under account info column 1202 including account name column 1204 (including various illustrative fictitious names), and account ID 1206, exemplary SEO marketing effort column 1208 including exemplary effort column 1210 and exemplary rank column 1212, exemplary product level effort column 1214, including exemplary effort column 1216, and rank column 1218, current info column 1220, including products found 1222, below MAP 1224 column, and last updated column 1226, illustrating exemplary map breaks associated with each account, including exemplary historical info 1228, including exemplary accounting crawls column 1230, breaking MAP column 1232, and Total MAP violation 1234 column, and providing, according to an exemplary embodiment, the featured ability to receive a selection of which accounts the exemplary client user may want to email in an automail column 1238 of exemplary communication history column 1236, which may include additional columns total email sent 1240, last email sent 1242, and send email selection column 1244, according to an exemplary embodiment. According to an exemplary embodiment, the user interface may permit sending emails based on a customized email templates to each account based on the account's MAP breaks.

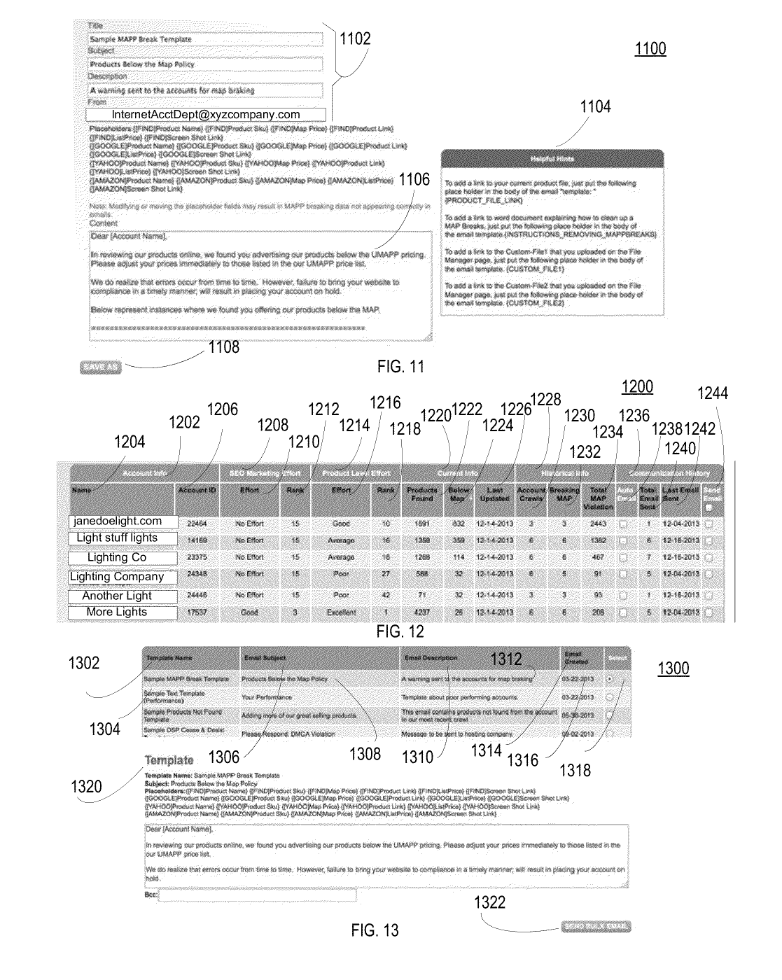

FIG. 13 depicts an exemplary image screenshot 1300 illustrating an exemplary screen, which may include an exemplary image of an exemplary user interface showing an exemplary feature, which may be used by a client user to provide an ability for an exemplary client to pursue enforcing the client's MAP policy: selecting the account's check box from the interface illustrated in FIG. 12, selecting by client of a template from a template in column 1302, such as, e.g., the sample exemplary MAP break template 1304, which may include an email subject 1306, such as products below MAP policy 1308, and an email description column 1310 such as a warning sent to the accounts for MAP breaking 1312, with a creation date 1314, which may include an example date 1316, and a radio button selection element 1318, to receive a client user selection, to send map break emails using the selected template 1320 listed, which is customizable using an exemplary editable fields, and cc: and/or bcc: fields may be provided, and/or Clicking the “SEND BULK EMAIL” button 1322 may provide an exemplary client the way to send the account an email based on the template, such as an email for providing an exemplary method of managing and/or enforcing the client's MAP policy, according to one exemplary embodiment.

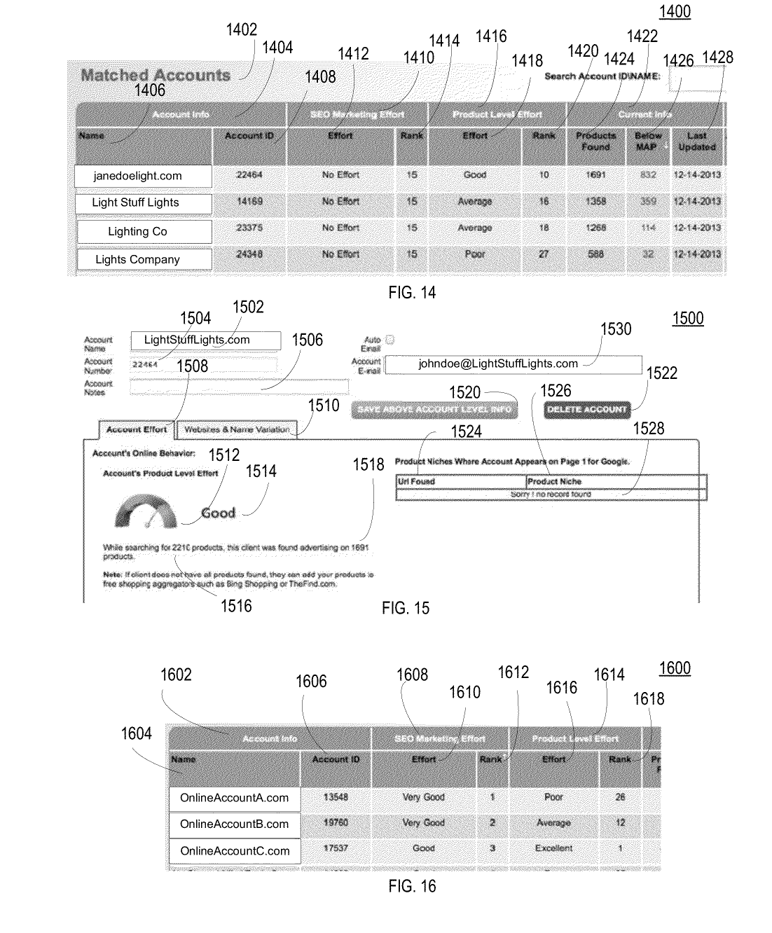

FIG. 14 depicts an exemplary image screenshot 1400 illustrating an exemplary matched accounts screen 1402, which may include an exemplary user interface showing an exemplary aggregate level results under “Product Level Effort” column 1416 heading where you see Effort (Grade) 1418, and Rank (list from 1 to total # of accounts) 1420, according to an exemplary embodiment. Additional exemplary columns account info 1404 including account name 1406 (including an illustrative list of fictitious account names), account id 1408, SEO marketing effort 1410, effort 1412, rank 1414, and current info column 1422, including products found 1424, below MAP 1426, and last updated column 1428, according to an exemplary embodiment. This information may relate to presenting information found on products and pricing, and may include, in an exemplary embodiment, presenting account level aggregate results: such as the total number of products found, as well as, assigning rankings for each account based on number of products found for each accounts, grading each account based on the total number of products found versus the total number of products the clients is giving an account to sell, according to an exemplary embodiment.

FIG. 15 depicts an exemplary image screenshot 1500 illustrating an exemplary screen of a user interface, which may include showing an exemplary specific account level for an exemplary illustrated account LigthStuffLights.com (fictitious), according to an exemplary embodiment. Note in screen 1500 how the MAP management system may allow accessing account effort 1508 for an account having a name 1502, and an account number 1504 search for 2210 products 1516, which were found and found the account advertising on 1691 products 1518, according to an exemplary embodiment. This resulted in the account having a grade of “Good” 1514, as illustrated graphically in speedometer 1512, according to an exemplary embodiment. Other information including account email, automail, account email field, product niche URL found 1524 and product niche 1526 may list any records found 1528, according to an exemplary embodiment. A tab 1510 may allow the user to navigate the websites and name variation 1510, according to an exemplary embodiment. Account level info may be saved by using the save button 1520. An account may be deleted using delete account 1522, according to an exemplary embodiment. This information, according to an exemplary embodiment, may relate to presenting account level aggregate results: such as the total number of products found; analyzing the total number of products found verses the total number of products the clients has given each account to sell; assigning rankings for each account based on number of products found for each accounts; grading each account based on the total number of products found verses the total number of products the clients is giving account to sell, according to an exemplary embodiment.

FIG. 16 depicts an exemplary image screenshot 1600 illustrating an exemplary screen of an exemplary user interface, which may include various exemplary columns 1602-1618, showing, e.g., but not limited to, an exemplary aggregate level results under “SEO Marketing Effort” 1608 heading where Effort (Grade) 1610 and Rank (list from 1 to total # of accounts) 1612, according to an exemplary embodiment. Additional columns may include, e.g., Account info column 1602 may include account name info 1604 (including several illustrative fictitious account names), account ID 1606, product level effort 1614 (may include effort 1616, or rank 1618), in an exemplary embodiment. This information may be referenced in exemplary steps adding up the total number of times an account appeared in the top customer searches; grading each account based on the total number of times the account appeared in top customer searches verses to the total number of searches made; presenting information found on products and pricing; presenting account level aggregate results, such as the total number of times the account was found and the grade of the account; and/or providing functionality of sorting accounts based on efforts, according to an exemplary embodiment.

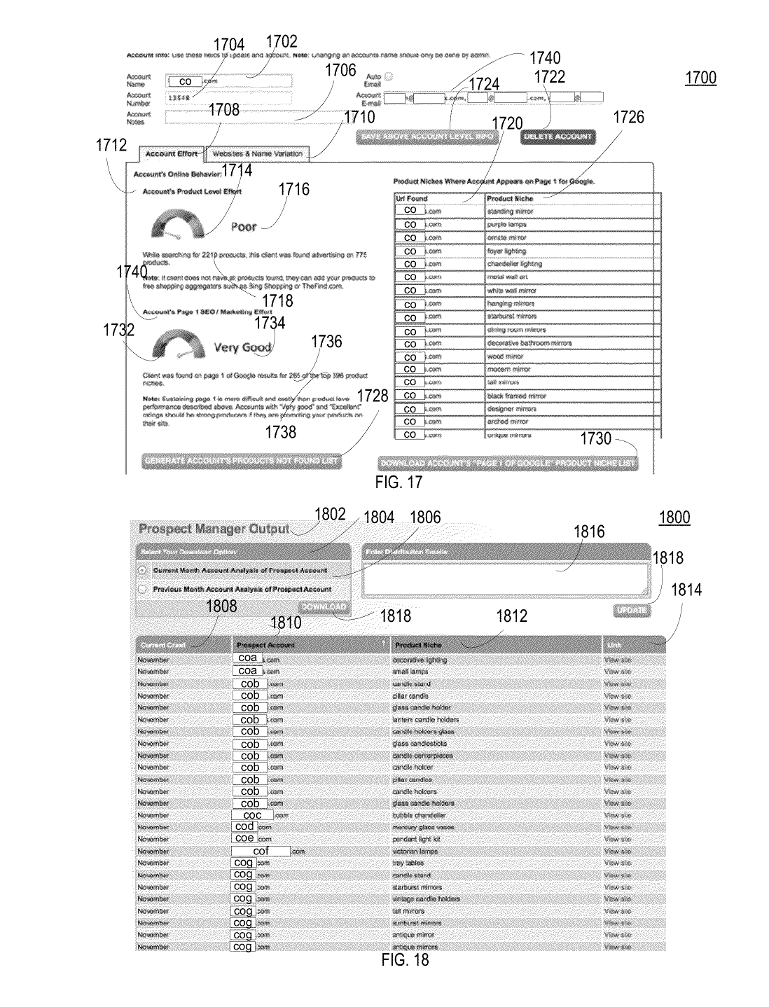

FIG. 17 depicts an exemplary image screenshot 1700 illustrating an exemplary screen of an exemplary user interface, which may include an exemplary bottom left meter (Very Good) 1732, 1734 showing the SEO effort 1740, the exemplary fictitious account co.com is making and the results that this account appeared in the top 265 1736 of 396 customer search/product niches 1738 for this client, according to an exemplary embodiment. Various fields are shown including account name 1702, account number 1704, account notes 1706, account effort tab 1708, alternative tab websites and name variation 1710, account product level effort 1712 including graph 1714, and poor rating 1716, as well as email address field, save account level info button 1724, delete account 1722, URL found 1720, and product niche 1726, generate account's products not found list 1728, and download account's page 1 of Google product niche list 1730, according to an exemplary embodiment. This information may be referenced in an exemplary step of adding up the total number of times an account appeared in the top customer searches; grading each account based on the total number of times the account appeared in top customer searches verses to the total number of searches made; presenting information found on products and pricing, including presenting account level aggregate results, such as the total number of times the account was found and the grade of the account, including providing functionality of sorting accounts based on efforts. Also in the grid to the right the interface may display, e.g., all of the actual product niches and what website were found of associating the top customer search values to the accounts and/or account website from of receiving client's account information (information regarding the name of the exemplary illustrated account advertising clients products and/or the actual account websites that are advertising for sale client products on the Internet), according to an exemplary embodiment.

FIG. 18 depicts an exemplary image screenshot 1800 illustrating an exemplary screen of an exemplary user interface, which may include an example of the exemplary prospect manager output 1802, which may allow the client user to select a download option 1804 of various choices 1806, and a download selection button 1818, and distribution emails may be entered 1816, with an update button 1818, current crawl column 1808, prospect account 1810, exemplary product niche 1812 (such as, e.g., client search engine keywords), and link column 1814, according to an exemplary embodiment. An exemplary embodiment may include various steps, which may include, gathering the account names and websites that were found in the search results for the top customer searches, which identifies prospective accounts, we often refer to it as our “prospect manager” because it helps client's identify ecommerce sites succeeding online who they may to pitch to sign up and carry its products; filtering out existing accounts of the client; and presenting those prospect accounts 1810 which appear in search engine results which are not current accounts of the client, according to an exemplary embodiment.

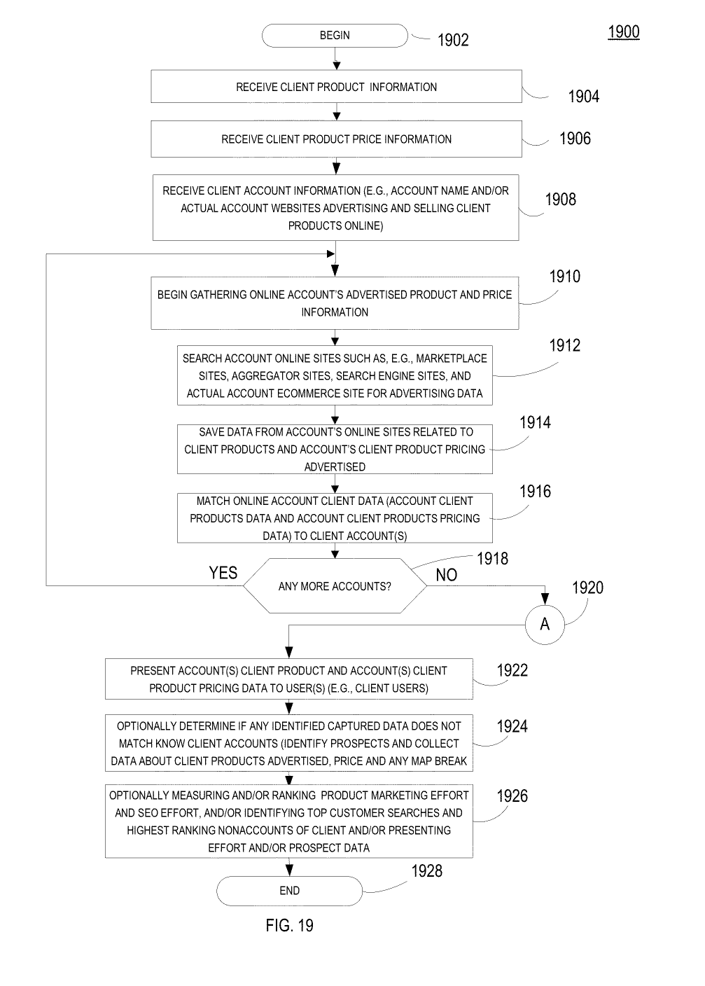

FIG. 19 depicts an exemplary flow diagram 1900 of an exemplary MAPP management method of managing a client's accounts, and reviewing account advertised pricing of client products, including optional identifying of nonmatching accounts, and optional effort measurement and ranking, according to an exemplary embodiment.

Flow diagram 1900 may begin with 1902 and may continue immediately with 1904, according to an exemplary embodiment.

In 1904, flow diagram 1900 may receive client product information, according to an exemplary embodiment. From 1904, flow diagram 1900 may continue with 1906.

In 1906, flow diagram 1900 may receive client product price information 1906, according to an exemplary embodiment. From 1906, flow diagram 1900 may continue with 1908.

In 1908, flow diagram 1900 may receive client account information (e.g., account name and/or actual account websites advertising for sale client products online), according to an exemplary embodiment. From 1908, flow diagram 1900 may continue with 1910.

In 1910, flow diagram 1900 may begin gathering online account's advertised product and price information, according to an exemplary embodiment. From 1910, flow diagram 1900 may continue with 1912.

In 1912, flow diagram 1900 may search account online sites such as, e.g., marketplace sites, aggregator sites, search engine sites, and actual account ecommerce sites for advertising data, according to an exemplary embodiment. From 1912, flow diagram 1900 may continue with 1914.

In 1914, flow diagram 1900 may save data from account's online sites related to client products and account's client product pricing advertised, according to an exemplary embodiment. From 1914, flow diagram 1900 may continue with 1916.

In 1916, flow diagram 1900 may match online account client data (account client products data and account client products pricing data) to client account(s), according to an exemplary embodiment. From 1916, flow diagram 1900 may continue with 1918.

In 1918, flow diagram 1900 may determine whether there are any additional client accounts to process, and if so, then may proceed to 1910, otherwise, flow diagram 1900 may continue with 1920, according to an exemplary embodiment. From 1920, flow diagram 1900 may continue with 1922.

In 1922, flow diagram 1900 may present account(s) client product and account(s) client product pricing data to user(s) (e.g., client users), according to an exemplary embodiment. From 1922, flow diagram 1900 may continue with 1924.

In 1924, flow diagram 1900 may optionally determine if any identified captured data does not match known client accounts (i.e., may identify prospects and collect data about client products advertised, price, and any MAP break, according to an exemplary embodiment. From 1924, flow diagram 1900 may continue with 1926.

In 1926, flow diagram 1900 may optionally measure and/or rank, product marketing effort and/or search engine optimization (SEO) effort, and/or may identify top customer searches and highest ranking nonaccounts of client and/or presenting effort and/or prospect data, according to an exemplary embodiment. From 1926, flow diagram 1900 may continue immediately with 1928, and may end.

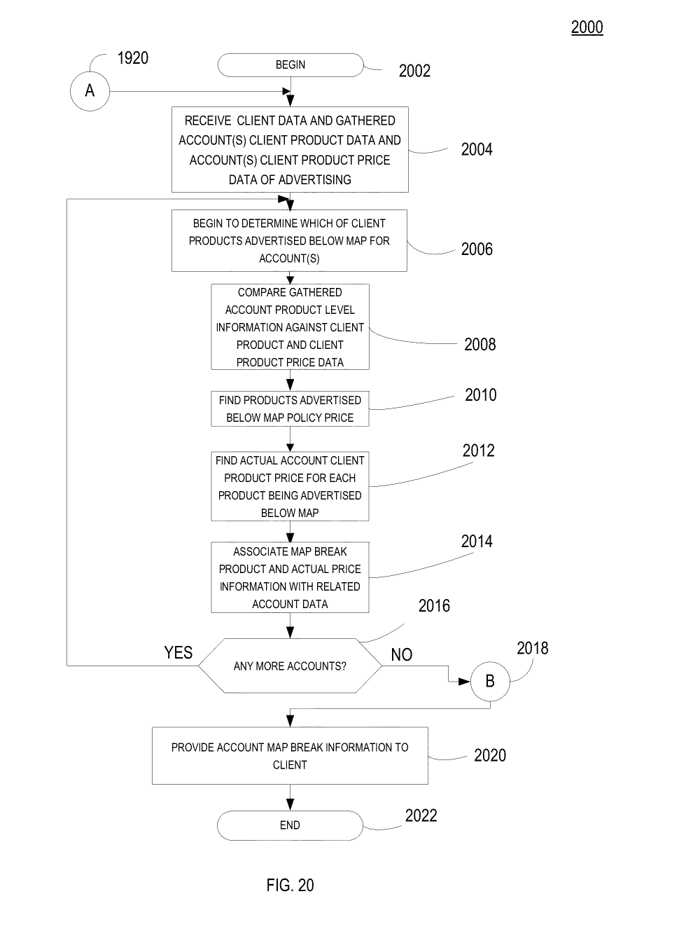

FIG. 20 depicts an exemplary flow diagram 2000 of an exemplary MAPP management method of determining MAP policy breaks, according to an exemplary embodiment.

Flow diagram 2000 may begin with 2002 and may continue immediately with 2004, according to an exemplary embodiment. According to an exemplary embodiment, the client account client product and account client price data may be received from 1920, according to an exemplary embodiment.

In 2004, flow diagram 2000 may receive client data and gathered account(s) client product data account(s) client product price data of advertising, according to an exemplary embodiment. From 2004, flow diagram 2000 may continue with 2006.

In 2006, flow diagram 2000 may begin to determine which of client products may be advertised below map for account(s) receive client product price information 2006, according to exemplary embodiment. From 2006, flow diagram 2000 may continue with 2008.

In 2008, flow diagram 2000 may compare gathered account product level information against client product and client product price data, according to an exemplary embodiment. From 2008, flow diagram 2000 may continue with 2010.

In 2010, flow diagram 2000 may find products advertised below MAP policy price, according to an exemplary embodiment. From 2010, flow diagram 2000 may continue with 2012.

In 2012, flow diagram 2000 may find an actual account client product price for each client product being advertised below MAP, according to an exemplary embodiment. From 2012, flow diagram 2000 may continue with 2014.

In 2014, flow diagram 2000 may associate the MAP break product (e.g., product SKU), and the actual price information of the account client product advertising with the related account data, according to an exemplary embodiment. From 2014, flow diagram 2000 may continue with 2016.

In 2016, flow diagram 2000 may determine whether there are any additional client accounts to process, and if so, then may proceed to 2006, otherwise, flow diagram 2000 may continue with 2018, according to an exemplary embodiment. From 2018, flow diagram 2000 may continue with 2020.

In 2018, flow diagram 2000 may provide, e.g., but not limited to, various data for further processing, such as, e.g., but not limited to, the client product data, client product price data, client product MAP data, client account data, the client's account(s) MAPP break information, if any, etc., according to an exemplary embodiment. From 2018, flow diagram 2000 may continue with 2020.

In 2020, flow diagram 2000 may also provide the client's account MAPP break information to a client user, by, e.g., displaying a list of MAPP breaks, etc., according to an exemplary embodiment. From 2020, flow diagram 2000 may continue immediately with 2022, and may end, according to an exemplary embodiment.

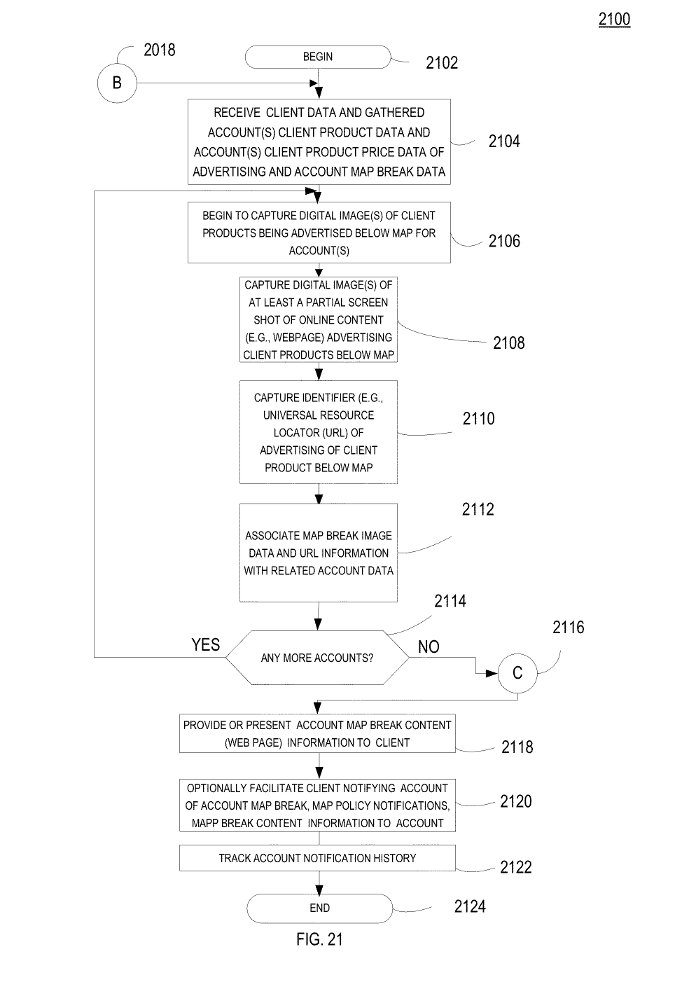

FIG. 21 depicts an exemplary flow diagram 2100 of an exemplary MAPP management method of capturing images of identified MAPP breaks, providing for optional automated notifications, and optional notification history creation and access, according to an exemplary embodiment.

Flow diagram 2100 may begin with 2102 and may continue immediately with 2104, according to an exemplary embodiment. According to an exemplary embodiment, various client data may be received for further processing, such as, e.g., but not limited to, client product data, client product price data, client account data, the client account client product and account client price data from advertising, and client account MAPP break data, if any, may be received from 2018, according to an exemplary embodiment.

In 2104, flow diagram 2100 may receive the client data and gathered account(s) client product data, and account(s) client product price data of advertising, and any account MAPP break data, according to an exemplary embodiment. From 2104, flow diagram 2100 may continue with 2106.

In 2106, flow diagram 2100 may begin to capture exemplary digital images (or other content) of client products being advertised below MAPP for an account(s), according to an exemplary embodiment. From 2106, flow diagram 2100 may continue with 2108.

In 2108, flow diagram 2100 may capture digital image(s) (and/or other content data) of at least a partial screenshot of online content (e.g., webpage content, etc.) showing advertising of client products below MAPP, according to an exemplary embodiment. From 2108, flow diagram 2100 may continue with 2110.

In 2110, flow diagram 2100 may capture an identifier such as, e.g., but not limited to, a universal resource locator (URL) of account advertising of the client product(s) below MAPP, according to an exemplary embodiment. From 2110, flow diagram 2100 may continue with 2112.

In 2112, flow diagram 2100 may associate the any MAPP break image and/or other content and URL information of the MAPP break data with the client account data of the related account, according to an exemplary embodiment. From 2112, flow diagram 2100 may continue with 2114.

In 2114, flow diagram 2100 may determine whether there are any additional client accounts to process, and if so, then may proceed to 2106, otherwise, flow diagram 2100 may continue with 2116, according to an exemplary embodiment. From 2116, flow diagram 2100 may continue with 2118, according to an exemplary embodiment.

In 2116, flow diagram 2100 may provide the captured image and/or other content relating to the MAPP break of the account along with any other client data, and/or related account data, to make the data for further processing, according to an exemplary embodiment. From 2116, flow diagram 2100 may continue with 2118.

In 2118, flow diagram 2100 may provide and/or present (e.g., display, etc.) the account(s)' MAPP break content (e.g., webpage, etc.) information to user(s) such as, e.g., but not limited to, a client user, according to an exemplary embodiment. From 2118, flow diagram 2100 may continue with 2120.

In 2120, flow diagram 2100 may also optionally facilitate the client to notify the account(s) of various automated notifications, such as, e.g., but not limited to, MAP policy information, MAPP break content information, links to MAP break image(s) content, other MAP break information, and may provide an automated way to provide the account MAPP break information, such as, e.g., but not limited to, by automated email, using, e.g., a customizable email template, etc., according to an exemplary embodiment. From 2120, flow diagram 2100 may continue with 2122.

In 2122, flow diagram 2100 may also maintain an account notification history for the client, tracking historically, any notifications regarding MAPP breaks by associate, for example, to make available a record of such notifications, for later review of MAPP breaks, notifications, etc., according to an exemplary embodiment. From 2122, flow diagram 2100 may immediately continue with 2124, and may end, according to an exemplary embodiment.

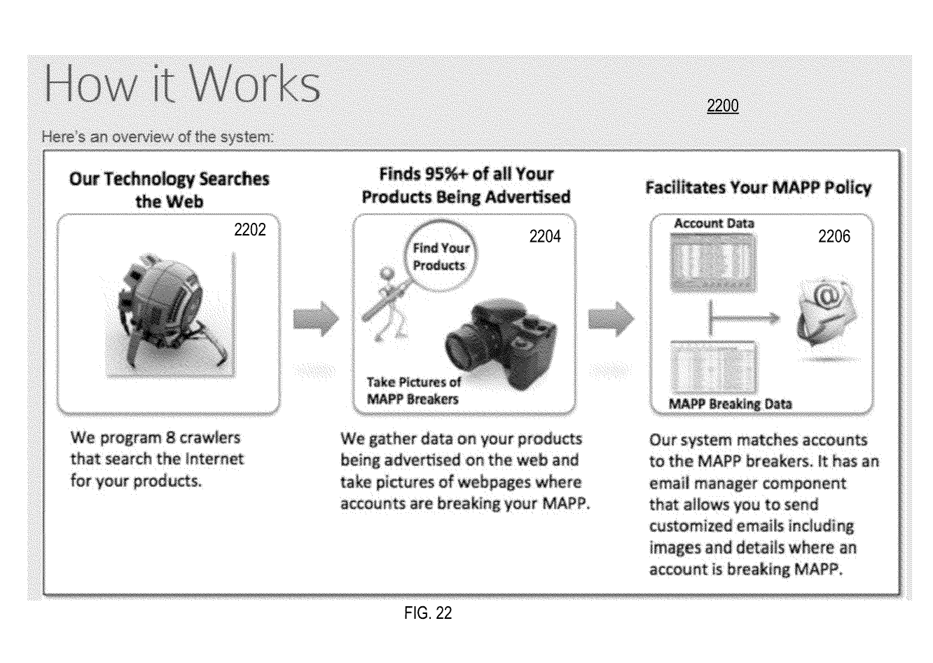

FIG. 22 depicts an exemplary high level diagram 2200 providing an exemplary high level overview of how an exemplary MAPP management method may work, according to an exemplary embodiment. The diagram 2200 may include, e.g., but may not be limited to, an illustration of an exemplary image 2202 representing and describing how an exemplary embodiment of the exemplary MAPP management system may search the Internet for advertising of client products; an illustration of an exemplary image 2204 representing, and describing how an exemplary embodiment of the MAPP management system may gather data on the client products being advertised on the Internet, and may capture images or other content of Internet content showing a client account(s) breaking MAPP; and an illustration of an exemplary image 2206 representing and describing the exemplary MAPP management system matching accounts with MAPP breakers and illustrates an exemplary account notifier and/or email manager that may allow sending of customized emails, which may be tailored to a client's MAP policy, to provide notifications, and/or a history of MAPP breaks, according to an exemplary embodiment.

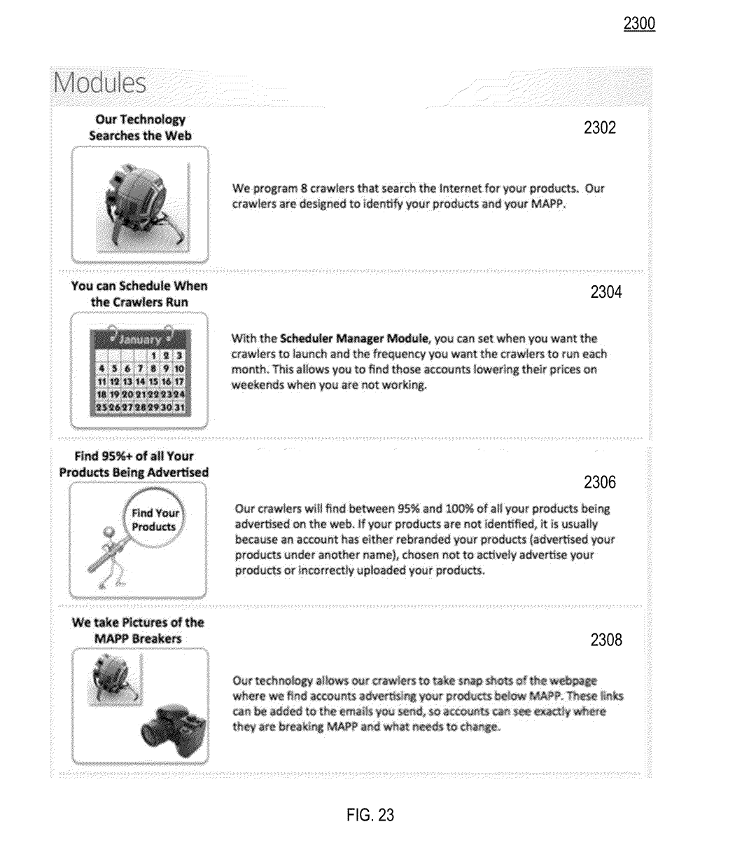

FIG. 23 depicts an exemplary high level description diagram 2300 providing an exemplary high level overview of various exemplary modules of an exemplary MAPP management method, according to an exemplary embodiment. The diagram 2300 may include, e.g., but may not be limited to, an exemplary illustration of search tool(s) 2302, which may illustrate exemplary software application crawlers, which may search for an identify client products and MAP policy information data; an exemplary illustration of an exemplary scheduler management module tool(s) 2304, which may illustrate exemplary module(s), which may set automated launching of search crawlers, based on an exemplary customizable frequency, such as, e.g., periodically, and/or monthly, enabling identifying MAPP breaks occurring in off hours, etc.; an exemplary illustration of search tool(s) 2306, which may illustrate how the exemplary MAPP management system may find a large, substantial proportion, e.g., approximately 95-100% of instances of a client's client products being advertised on the Internet, and may help to identify, advertising of products with errors, and/or marketing and SEO optimization efforts, etc.; and/or an exemplary illustration of search tool(s) 2308, which may illustrate exemplary technology, which may capture image(s) and/or other content preserving proof of a MAPP break, and/or identifying advertising content in need or correction and/or update, so a client may indicate details of MAPP breaks to an account, and where to find the advertising content needing update, according to exemplary embodiment.

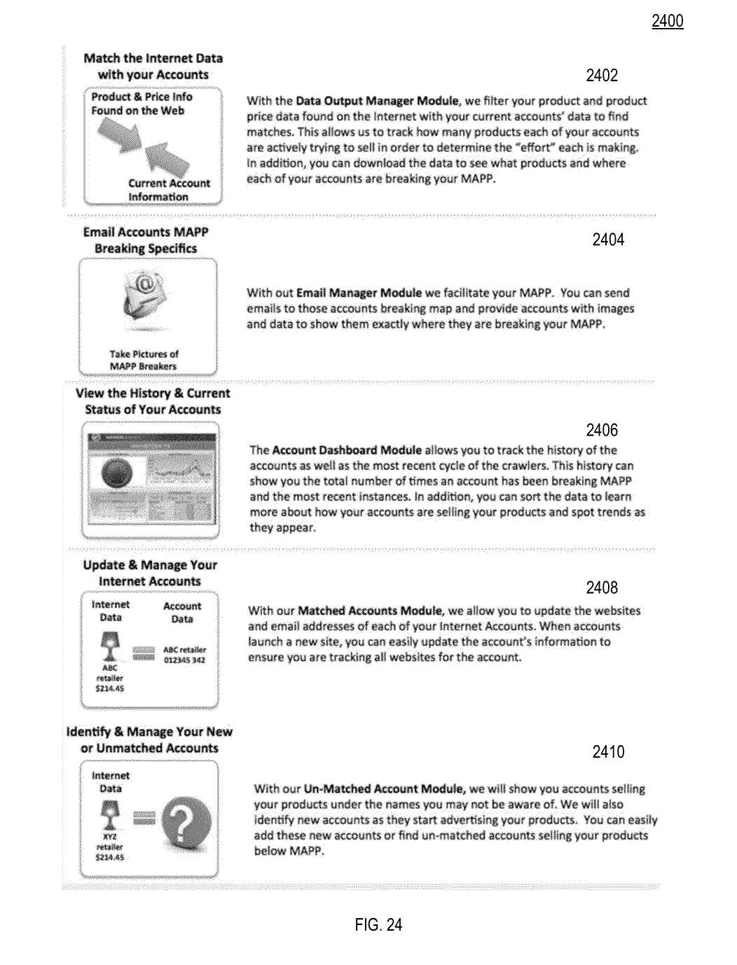

FIG. 24 depicts an exemplary high level description diagram 2400 providing a further exemplary high level overview of various additional exemplary modules of an exemplary MAPP management method, according to an exemplary embodiment. The diagram 2400 may include, e.g., but may not be limited to, an exemplary illustration of an exemplary data output manager 2402, which may illustrate exemplary software which may filter client products and client product price data found on the Internet with current Account(s')'s data to find client product matches, and how many client products account is actively advertising for sale, determining effort, and allowing downloading of data and/or identifying where account(s) are breaking MAPP; an exemplary illustration of an exemplary email manager module tool(s) 2404, which may illustrate an exemplary module(s), which may allow a client to automate MAPP break notifications, facilitating your MAP policy, allowing sending of an exemplary email or other notification to your accounts notifying the account of a MAPP break, showing examples, and indicating what content (and associated location) needs to be updated, when an account is breaking MAPP, etc.; an exemplary illustration of account dashboard module 2406, which may illustrate an exemplary account dashboard application module, which may allow client tracking of a history of accounts, as well as reviewing a most recent cycle of crawlers, the history may indicate the total number of times an account(s) has broken MAPP, and may include instances of recent MAPP breaks, and data may be sorted and/or filtered, and may be used to determine trends, to identify marketing/advertising effort, SEO optimization effort, etc.; an exemplary illustration of matched accounts module 2408, which may illustrate an exemplary matched account(s) dashboard application module, which may allow managing maintaining an updated list of account websites, and other contact information, such as, e.g., but not limited to, email addresses, etc., as well as tracking all related websites of any given account(s), etc.; and/or an exemplary illustration of an exemplary un-matched account module tool(s) 2410, which may illustrate exemplary technology, which may provide a listing of accounts which may be advertising for sale your client products under, e.g., but not limited to, names that a client is not aware of, or may be selling without your being aware of the account, thus identifying potential new accounts advertising client products, the dashboard may provide a way to associate an unmatched account with an existing account thus updating the client's matched account list for that given account, and this dashboard may further permit identifying an unknown account, which may be advertising below MAPP, or may be investing in marketing effort and/or SEO optimization, etc., according to exemplary embodiment.

FIG. 25 depicts an exemplary software architecture diagram 2500, according to an exemplary embodiment. Various exemplary modules discussed herein, including those discussed with reference to FIGS. 23 and 24 above, may be illustrated as an application layer 2506-2520 of an exemplary software architecture diagram 2500, with an exemplary hardware layer 2502 at an exemplary base, with an operating system (OS) and/or middleware layer 2504, atop the exemplary hardware layer 2502. Exemplary application modules may include, e.g., but are not limited to, an exemplary MAPP management application service provider application 2506, an exemplary client product data, client product price data, client account data access and/or storage module 2508, an exemplary database management system 2510, which may serve as an exemplary data warehouse for the various data accessed by the various other modules, an exemplary client MAPP data and/or notification system 2512, an exemplary prospect manager 2514, which may provide business intelligence tools to identify potential new accounts, as well as accounts investing in effort, etc., an exemplary effort measurement meter module and/or tool operative to measure product level marketing/advertising (which may be price per click advertising level driven) and/or search engine optimization (SEO) effort measurement tool 2516, identifying accounts investing in SEO to appear in search results for important client search term(s), an exemplary product pricing data collection application software agent and/or spider and/or crawler application 2518, which may gather and capture data regarding, e.g., but not limited to, client product advertising, client product price advertising by account(s), etc., and/or web server(s) 2520, and/or other application server(s), (such as, e.g., but not limited to, email mailbox systems, alert and/or notification systems, collaboration systems, social network systems, routing tables, relational and/or graph databases, internet browser based systems, client and/or server communication stack modules, messaging modules, discussion thread modules, note capture, account data capture and storage, client data capture and storage, etc.), and/or any of various other modules described, and or implied elsewhere, herein. According to one exemplary embodiment, various applications may be shown as appearing as being executed on, (or stored in or on) one or more example systems, however, various alternative exemplary embodiments may also be used where some portions of data and/or applications may be stored and/or executed on one system, and/or other portions of data and/or applications may be stored in and/or executed on another system or additional multiple systems, local, and/or remote to, any of the given systems. Similarly, where data and/or programs are shown as executing on separate computing devices in exemplary embodiments, in alternative exemplary embodiments, such separate systems may be stored in and/or executed on a single system, and thus reference to “at least one processor” should be understood to refer to one or more separate computing device systems, and/or a single system having one or more processor devices within it, etc.

FIG. 5 depicts an exemplary diagram 500 illustrating an exemplary computer/communications device hardware architecture as may be used in various components including, e.g., but not limited to, devices 102, 104, 120, 130, 106 of 1C, 110 of 1C, 114 of 1C, 106 of 1D, 108 of 1D, 110 of 1D, and 112 of 1D, according to exemplary embodiments of the present invention. FIG. 5 depicts an exemplary diagram 500 illustrating an exemplary computer/communications device hardware architecture as may be used in various components of exemplary embodiments of the present invention. FIG. 5 depicts an exemplary view 500 of an exemplary computer system 102, 104, 112 as may be used in implementing an exemplary embodiment of the present invention. FIG. 5 depicts an exemplary embodiment of a computer system that may be used in computing devices such as, e.g., but not limited to, user devices 102, 102a, 102b, promotions service provide device 108, 108a, 108b, and/or web server 108a and/or application server 108b, social network computing device(s) 112 of social network 110, vendor user devices 116, 116a, 116b and 114, network components 104, etc. according to an exemplary embodiment of the present invention. FIG. 5 depicts an exemplary embodiment of a computer system that may be used as client device 108, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/8/8.1 . . . , etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y, U.S.A, Mac/OS, OS/X, iOS from APPLE® Corporation of Cupertino, Calif., U.S.A, etc, Android, available from Google, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPod, an iPhone, a smartphone, an iPad, a tablet based device, a smart phone, an ANDROID OS device, an iOS device, a Symbian based device, a Windows 8 device, etc., may also be implemented using a computer such as that shown in FIG. 5.

The computer system 500 may include one or more processors, such as, e.g., but not limited to, processor(s) 504. The processor(s) 504 may be connected and/or coupled to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot, PC Card, SDRAM, universal serial bus (USB), solid state device (SSD), and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

In another exemplary embodiment, the invention may be directed to a computer program product may include a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g, (including, e.g., but not limited to IEEE 802.11g-2003, etc.), etc.

### CONCLUSION

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents.

What is claimed is:

1. A computer-implemented method of gathering online product pricing information from online sites advertising at least one product of a client, comprising:
receiving, by at least one processor, at least one client product information and client product price information of the at least one client product;
receiving, by the at least one processor, account information of the client
wherein the account information comprises at least one of:
information regarding a name of an account advertising the at least one client products, or
an identifier of an online account website advertising at least one client product and at least one client product price on the Internet;
gathering, by the at least one processor, advertised client product and advertised client product price information of at least one online account comprising:
searching, by the at least one processor, at least one online site
wherein said at least one online site comprises at least one of:
at least one marketplace site,
at least one aggregator site,
at least one search engine site, or
at least one account ecommerce site;
saving, by the at least one processor, the online advertised product data and the online advertised pricing data from the at least one online site related to the at least one client product and the client product pricing; and
matching, by the at least one processor, the online advertised product data and the online advertised pricing data to the at least one online account of the client; and
presenting, by the at least one processor, the online advertised product data and the online advertised product price data for the at least one online account of the client related to the client product and client product pricing.

2. The method according to claim 1, further comprising:
finding, by the at least one processor, the online advertised product data and the online advertised pricing data of the at least one online account, advertising the at least one client product below a minimum advertised price (MAP), comprising:
determining, by the at least one processor, the at least one online advertised product,
corresponding to the at least one client product, advertised below MAP to obtain MAP break information, comprising:
comparing, by the at least one processor, the advertised product information gathered for each account from said gathering against the client product information of said receiving of the client product information comprising:
finding, by the at least one processor, the online advertised product of the at least one client product advertised below the MAP, if any; and
finding, by the at least one processor, the actual online advertised price of each of the online advertised products being advertised below the MAP, if any; and
associating, by the at least one processor, the map break information found in said comparing to a correct account based on the account information.

3. The method according to claim 2, further comprising:
capturing, by the at least one processor, digital evidence of account advertising products below MAP, comprising:
capturing, by the at least one processor, at least one digital image of at least one client product being advertised below MAP, comprising:
taking, by the at least one processor, the at least one digital image comprising at least a portion of a screen shot of an online page advertising the at least one client product below MAP;
capturing, by the at least one processor, a universal remote locator (URL) of the actual advertised product price in account online advertising of the at least one client product; and
associating, by the at least one processor, the at least one digital image with the correct account and client product.

4. The method according to claim 3, further comprising:
finding, by the at least one processor, at least one unauthorized account or unauthorized entity advertising the at least one client product online, comprising:
identifying, by the at least one processor, the captured data from at least one crawl that does not match a known client accounts, comprising:
finding, by the at least one processor, at least one previously unknown account or unauthorized entity advertising the at least one client product;
finding, by the at least one processor, a total number of the at least one client product on which the previously unknown account or unauthorized entity is advertising;
finding, by the at least one processor, for the previously unknown account or unauthorized entity, any advertising of the at least one client product below MAP;
finding, by the at least one processor, a below MAP advertised client product of the at least one client product, if any, which the previously unknown account or unauthorized entity is advertising below MAP; and
finding, by the at least one processor, a below MAP advertised price of the below MAP advertised client product, which the previously unknown account or unauthorized entity is advertising below MAP.

5. The method according to claim 4, further comprising:
facilitating managing or enforcing, by the at least one processor, of a MAP policy online for the client, comprising at least one of:
displaying, by the at least one processor, account map break findings comprising:
presenting, by the at least one processor, account level aggregate map break results comprising at least one of the total number of products found; or the total number of products listed below MAP found;
presenting, by the at least one processor, specific account level results comprising at least one of:
presenting, by the at least one processor, the actual links to online pages with online advertised product and online advertised product price advertised below MAP; or
presenting, by the at least one processor, the at least one digital image of the at least the portion of the screen shot of the online page with the advertised product and the actual advertised product price advertised below MAP; or
providing, by the at least one processor, a notification to an account of the MAP break of the account, if any, said providing comprising:
creating, by the at least one processor, an email template customizable by the client based on a MAP policy of the client, comprising:
creating, by the at least one processor, a specific email with a customized template message of the client; and
customizing, by the at least one processor, the specific email containing the actual MAP break information for each account showing the actual MAP break information comprising at least one of:
the online advertised product that account has listed below MAP;
the online advertised price of each online advertised product advertised below MAP by the account;
the correct MAP price the account should not be advertising below;
the URL including a hyperlink to the online page advertising the at least one client product and the actual advertised product price; or
a hyperlink to a stored date-stamped copy of the at least one digital image of the at least the portion of the screen shot of the online page advertising the at least one client product below MAP;
sending, by the at least one processor, at least one customized MAP break email to an account based on the MAP break of the account, if any; and
tracking, by the at least one processor, a history of the at least one customized MAP break email sent to an account.

6. The method according to claim 1, wherein said gathering further comprises:
measuring, by the at least one processor, an external product-level marketing effort by the at least one online account of advertising the at least one client product, comprising:
adding up, by the at least one processor, a total number of products found for each account;
analyzing, by the at least one processor, a total number of products found versus the total number of the client products the client has given the account to sell;
assigning, by the at least one processor, at least one ranking for each account based on the total number of products found for each account; and
grading, by the at least one processor, each account based on the total number of products found verses the total number of products the clients is giving account to sell; and
wherein said presenting further comprises at least one of:
presenting, by the at least one processor, account level aggregate results;
presenting, by the at least one processor, account level aggregate results comprising the total number of products found;
presenting, by the at least one processor, actual account level product results; or
providing, by the at least one processor, sorting of accounts based on the efforts.

7. The method according to claim 1, further comprising:
identifying, by the at least one processor, effort, at least one online account of the client, is making to appear on a top page of at least one search engine for at least one of:
at least one top customer search, or at least one product niche related to the client, comprising:
determining, by the at least one processor, the at least one top customer search in the at least one search engine related to the client products;
crawling, by the at least one processor, the at least one search engine site for search results for the at least one top customer search;
gathering, by the at least one processor, at least one account name and at least one site found in the search results for the at least one top customer search;
associating, by the at least one processor, the at least one top customer search values to the at least one account or the account online site of the account information;
adding up, by the at least one processor, a sum of the total number of times the at least one account appeared in the at least one top customer search; and
grading, by the at least one processor, each of the at least one account based on the total number of times the account appeared in the top customer searches versus to the total number of searches made; and
wherein said presenting, comprises at least one of:
presenting, by the at least one processor, the account level aggregate results;
presenting, by the at least one processor, the account level aggregate results comprising the total number of times the account was found;
presenting, by the at least one processor, the account level aggregate results comprising the grade of the account; or
providing, by the at least one processor, sorting of the at least one account based on the effort.

8. The method according to claim 7, further comprising:
identifying, by the at least one processor, prospective accounts making said effort to appear on the at least one top page of the search engine results for the top customer searches or the product niches related to the client, further comprising:
determining, by the at least one processor, the top customer searches in search engines related to the products offered by client;
crawling, by the at least one processor, Search Engine website for these top customer searches;
gathering, by the at least one processor, the account names and websites that were found in the search results for the top customer searches;
filtering, by the at least one processor, out existing accounts of the client; and
presenting, by the at least one processor, those accounts who are appearing in search engine results who are not current accounts of the client.

9. A system of gathering online product pricing information from online sites advertising at least one product of a client comprising:
at least one memory; and
at least one computer processor coupled to said at least one memory,
wherein said at least one computer processor is operative to:
receive at least one client product information and client product price information of the at least one client product;
receive account information of the client
wherein the account information comprises information regarding a name of an account advertising the at least one client products or an identifier of an online account site advertising the at least one client product on the Internet;
gather advertised client product and advertised client product price information of at least one online account comprising:
search at least one online site
wherein said at least one online site comprises:
at least one marketplace site,
at least one aggregator site,
at least one search engine site, or
at least one account ecommerce site;
save the online advertised product data and the online advertised pricing data from the at least one online site related to the at least one client product and the client product pricing; and
match the online advertised product data and the online advertised pricing data to the at least one online account of the client; and
present the online advertised product data and the online advertised product price data for the at least one online account of the client related to the client product and client product pricing.

10. The system according to claim 9, further comprising:
the at least one processor operative to
find the online advertised product data and the online advertised pricing data of the at least one online account, advertising the at least one client product below a minimum advertised price (MAP), comprising the at least one processor operative to:
determine the at least one online advertised product, corresponding to the at least one client product, advertised below MAP to obtain MAP break information, comprising, the at least one processor operative to:
compare the advertised product information gathered for each account from said gathering against the client product information of said receiving comprising, the at least one processor operative to:
find the online advertised product of the at least one client product advertised below the MAP, if any; and
find an actual advertised price of each of the online advertised product being advertised below the MAP; and
associate the map break information found in said comparing to a correct account based on the account information.

11. The system according to claim 10, further comprising:
wherein the at least one processor is operative to:
capture digital evidence of account advertising products below MAP, comprising, the at least one processor operative to:
capture at least one digital image of at least one client product being advertised below MAP, comprising the at least one processor operative to:
take the at least one digital image comprising at least a portion of a screen shot of an online page advertising the at least one client product below MAP;
capture a universal remote locator (URL) of the actual advertised product price in account online advertising of the at least one client product; and
associate the at least one digital image with the correct account and client product.

12. The system according to claim 11, further comprising:
wherein the at least one processor is operative to:
find at least one unauthorized account or unauthorized entity advertising the at least one client product online, comprising the processor operative to:
identify the captured data from at least one crawl that does not match a known client accounts, comprising the processor operative to:
find at least one previously unknown account or unauthorized entity advertising the at least one client product;
find a total number of the at least one client product on which the previously unknown account or unauthorized entity is advertising;
find for the previously unknown account or unauthorized entity, any advertising of the at least one client product below MAP;
find a below MAP advertised client product of the at least one client product, if any, which the previously unknown account or unauthorized entity is advertising below MAP; and
find a below MAP advertised price of the below MAP advertised client product, which the previously unknown account or unauthorized entity is advertising below MAP.

13. The system according to claim 12, further comprising:
wherein the at least one processor is operative to:
facilitate managing or enforcing of a MAP policy online for the client, comprising at least one of:
display account MAP break findings comprising the at least one processor operative to:
present account level aggregate map break results comprising the at least one processor operative to at least one of
the total number of products found; or
the total number of products listed below MAP found;
present specific account level results comprising the at least one processor operative to at least one of:
the actual links to online pages with online advertised product and online advertised product price advertised below MAP; or
the at least one digital image of the at least the portion of the screen shot of the online page with the advertised product and the actual advertised product price advertised below MAP; or
provide a notification to an account of the MAP break of the account, if any, said providing comprising the at least one processor operative to:
create an email template customizable by the client based on a MAP policy of the client, comprising the at least one processor operative to:
create a specific email with a customized template message of the client;
customize the specific email containing the actual MAP break information for each account showing the actual MAP break information comprising the at least one processor operative to at least one of:
the online advertised product that account has listed below MAP;
the online advertised price of each online advertised product advertised below MAP by the account;
the correct MAP price the account should not be advertising below;
the URL including a hyperlink to the online page advertising the at least one client product and the actual advertised product price; or
a hyperlink to a stored date-stamped copy of the at least one digital image of the at least the portion of the screen shot of the online page advertising the at least one client product below MAP;
send at least one customized MAP break email to each account based on the MAP break of the account, if any; and
track a history of the at least one customized MAP break email sent to an account.

14. The system according to claim 13,
wherein said gather further comprises wherein the at least one processor is operative to:
measure an external product-level marketing effort by the at least one online account of advertising the at least one client product, comprising the at least one processor operative to:
add up a total number of products found for each account;
analyze a total number of products found versus the total number of the client products the client has given the account to sell;
assign at least one ranking for each account based on the total number of products found for each account; and
grade each account based on the total number of products found verses the total number of products the clients is giving account to sell; and
wherein said presenting further comprises the at least one processor is operative to at least one of:
present account level aggregate results;
present account level aggregate results comprising the total number of products found;
present actual account level product results; or
provide sorting of accounts based on the efforts.

15. The system according to claim 9, further comprising:
wherein the at least one processor is operative to:
identify effort at least one online account of the client is making to appear on a top page of at least one search engine for at least one of: at least one top customer search, or at least one product niche related to the client, comprising the at least one processor operative to:
determine the at least one top customer search in the at least one search engine related to the client products;
crawl the at least one search engine site for search results for the at least one top customer search;
gather at least one account name and at least one site found in the search results for the at least one top customer search;
associate the at least one top customer search values to the at least one account or the account online site of the account information;
add up a sum of the total number of times the at least one account appeared in the at least one top customer search; and
grade each of the at least one account based on the total number of times the account appeared in the top customer searches versus to the total number of searches made; and
wherein said present, comprises wherein said processor is operative to at least one of:
present the account level aggregate results;
present the account level aggregate results comprising the total number of times the account was found;
present the account level aggregate results comprising the grade of the account; or
provide sorting of the at least one account based on the effort.

16. The system according to claim 15, further comprising:
wherein the at least one processor is operative to:
identify prospective accounts making an effort to appear on the at least one top page of the search engine results for the top customer searches or the product niches related to the client, further comprising the at least one processor operative to:
determine the top customer searches in search engines related to the products offered by client;
crawl Search Engine website for these top customer searches;
gather the account names and websites that were found in the search results for the top customer searches;
filter out existing accounts of the client; and
present those accounts who are appearing in search engine results who are not current accounts of the client.

17. A computer program product embodied on a nontransitory computer accessible medium, comprising program logic, which when said program logic is executed on at least one computer processor performs a method comprising:
receiving, by at least one processor, at least one client product information and client product price information of the at least one client product;
receiving, by the at least one processor, account information of the client
wherein the account information comprises at least one of:
information regarding a name of an account advertising the at least one client products; or
an identifier of an online account site advertising for sale the at least one client product on the Internet;
gathering, by the at least one processor, advertised client product and advertised client product price information of at least one online account comprising:
searching, by the at least one processor, at least one online site
wherein said at least one online site comprises at least one of:
at least one marketplace site,
at least one aggregator site,
at least one search engine site, or
at least one account ecommerce site;
saving, by the at least one processor, the online advertised product data and the online advertised pricing data from the at least one online site related to the at least one client product and the client product pricing; and
matching, by the at least one processor, the online advertised product data and the online advertised pricing data to the at least one online account of the client; and
presenting, by the at least one processor, the online advertised product data and the online advertised product price data for the at least one online account of the client related to the client product and client product pricing.

18. The computer program product according to claim 17, wherein said method further comprises:
finding, by the at least one processor, the online advertised product data and the online advertised pricing data of the at least one online account, advertising the at least one client product below a minimum advertised price (MAP), comprising:
determining, by the at least one processor, the at least one online advertised product, corresponding to the at least one client product, advertised below MAP to obtain MAP break information, comprising:
comparing the advertised product information gathered for each account from said gathering against the client product information of said receiving of the client product information comprising:
finding the online advertised product of the at least one client product advertised below the MAP, if any; and
finding the actual online advertised price of each of the online advertised products being advertised below the MAP, if any; and
associating the map break information found in said comparing to a correct account based on the account information.

19. The computer program product according to claim 18, wherein said method further comprises:
capturing digital evidence of account advertising products below MAP, comprising:
capturing at least one digital image of at least one client product being advertised below MAP, comprising:
taking the at least one digital image comprising at least a portion of a screen shot of an online page advertising the at least one client product below MAP;
capturing a universal remote locator (URL) of the actual advertised product price in account online advertising of the at least one client product; and
associating the at least one digital image with the correct account and client product.

20. The computer program product according to claim 19, wherein said method further comprises:
finding at least one unauthorized account or unauthorized entity advertising the at least one client product online, comprising:
identifying the captured data from at least one crawl that does not match a known client accounts, comprising:
finding at least one previously unknown account or unauthorized entity advertising the at least one client product;
finding a total number of the at least one client product on which the previously unknown account or unauthorized entity is advertising;
finding for the previously unknown account or unauthorized entity, any advertising of the at least one client product below MAP;
finding a below MAP advertised client product of the at least one client product, if any, which the previously unknown account or unauthorized entity is advertising below MAP; and
finding a below MAP advertised price of the below MAP advertised client product, which the previously unknown account or unauthorized entity is advertising below MAP.

21. The computer program product according to claim 20, wherein said method further comprises:
facilitating managing or enforcing of a MAP policy online for the client, comprising at least one of:
displaying account map break findings comprising:
presenting account level aggregate map break results comprising at least one of the total number of products found; or the total number of products listed below MAP found;
presenting specific account level results comprising at least one of:
presenting the actual links to online pages with online advertised product and online advertised product price advertised below MAP; or
presenting the at least one digital image of the at least the portion of the screen shot of the online page with the advertised product and the actual advertised product price advertised below MAP; or
providing a notification to an account of the MAP break of the account, if any, said providing comprising:
creating an email template customizable by the client based on a MAP policy of the client, comprising:
creating a specific email with a customized template message of the client; and
customizing the specific email containing the actual MAP break information for each account showing the actual MAP break information comprising at least one of:
the online advertised product that account has listed below MAP;
the online advertised price of each online advertised product advertised below MAP by the account;
the correct MAP price the account should not be advertising below;
the URL including a hyperlink to the online page advertising the at least one client product and the actual advertised product price; or
a hyperlink to a stored date-stamped copy of the at least one digital image of the at least the portion of the screen shot of the online page advertising the at least one client product below MAP;
sending at least one customized MAP break email to an account based on the MAP break of the account, if any; and
tracking a history of the at least one customized MAP break email sent to an account.

22. The computer program product according to claim 17, wherein said method further comprises:
measuring an external product-level marketing effort by the at least one online account of advertising the at least one client product, comprising:
adding up a total number of products found for each account;
analyzing a total number of products found versus the total number of the client products the client has given the account to sell; and
assigning at least one ranking for each account based on the total number of products found for each account; and
grading each account based on the total number of products found verses the total number of products the clients is giving account to sell; and
wherein said presenting further comprises at least one of:
presenting account level aggregate results;
presenting account level aggregate results comprising the total number of products found;
presenting actual account level product results; or
providing sorting of accounts based on the efforts.

23. The computer program product according to claim 17, wherein said method further comprises:
identifying effort, at least one online account of the client, is making to appear on a top page of at least one search engine for at least one of: at least one top customer search, or at least one product niche related to the client, comprising:
determining the at least one top customer search in the at least one search engine related to the client products;
crawling the at least one search engine site for search results for the at least one top customer search;
gathering at least one account name and at least one site found in the search results for the at least one top customer search;
associating the at least one top customer search values to the at least one account or the account online site of the account information;
adding up a sum of the total number of times the at least one account appeared in the at least one top customer search; and
grading each of the at least one account based on the total number of times the account appeared in the top customer searches versus to the total number of searches made; and
wherein said presenting, comprises at least one of:
presenting the account level aggregate results;
presenting the account level aggregate results comprising the total number of times the account was found;
presenting the account level aggregate results comprising the grade of the account; or
providing sorting of the at least one account based on the effort.

24. The computer program product according to claim 23, wherein said method further comprises:
identifying prospective accounts making said effort to appear on the at least one top page of the search engine results for the top customer searches or the product niches related to the client, further comprising:
determining the top customer searches in search engines related to the products offered by client;
crawling Search Engine website for these top customer searches;
gathering the account names and websites that were found in the search results for the top customer searches;
filtering out existing accounts of the client; and
presenting those accounts who are appearing in search engine results who are not current accounts of the client.

25. A method of identifying effort of at least one online account of a client is making to appear on a top page of at least one search engine for at least one of: at least one top customer search, or at least one product niche related to the client, the method comprising:
receiving, by at least one processor, client product information from the client;
receiving account information of the client,
wherein the account information comprises at least one of:
a name of the account advertising at least one client product, or
an actual account website advertising and advertising the at least one client product on the Internet;
determining, by the at least one processor, at least one top customer search in at least one search engine related to the at least one client product offered by client;
crawling, by the at least one processor, at least one search engine website for the at least one top customer search to obtain at least one search result;
gathering, by the at least one processor, the account name and website found in the at least one search result for the at least one top customer search;
associating, by the at least one processor, the at least one top customer search value with the account or the account website;
adding up, by the at least one processor, a total number of times a given account appeared in the at least one top customer search;
grading, by the at least one processor, each of the account based on the total number of times the account appeared in the at least one top customer search out of the total number of searches made; and
wherein said presenting information found on client products, further comprises at least one of:
presenting, by the at least one processor, account level aggregate results, comprising at least one of the total number of times the account was found, or the grade of the account; or
providing, by the at least one processor, functionality of sorting accounts based on efforts.

26. The method according to claim 25, wherein the method comprises:
identifying prospective accounts making said effort to appear on the at least one top page of the search engine results for the top customer searches or the product niches related to the client, further comprising:
determining, by the at least one processor, the top customer searches in search engines related to the products offered by client;
crawling, by the at least one processor, Search Engine website for these top customer searches;
gathering, by the at least one processor, the account names and websites that were found in the search results for the top customer searches;
filtering out, by the at least one processor, existing accounts of the client; and
presenting, by the at least one processor, those accounts who are appearing in search engine results who are not current accounts of the client.

27. A system of identifying effort of at least one online account of a client is making to appear on a top page of at least one search engine for at least one of: at least one top customer search, or at least one product niche related to the client, the system comprising:
at least one memory; and
at least one processor coupled to said at least one memory, said at least one processor operative to:
receive client product information from the client;
receive account information of the client,
wherein the account information comprises at least one of:
a name of the account advertising at least one client product, or
an actual account website advertising and advertising the at least one client product on the Internet;
determine at least one top customer search in at least one search engine related to the at least one client product offered by client;
crawl at least one search engine website for the at least one top customer search to obtain at least one search result;
gather the account name and website found in the at least one search result for the at least one top customer search;
associate the at least one top customer search value with the account or the account website;
add up a total number of times a given account appeared in the at least one top customer search;
grade each of the account based on the total number of times the account appeared in the at least one top customer search out of the total number of searches made; and
wherein said presenting information found on client products, further comprises wherein the at least one processor is operative to at least one of:
present account level aggregate results, comprising at least one of the total number of times the account was found or the grade of the account; or
provide functionality of sorting accounts based on efforts.

28. The system according to claim 27, wherein the system comprises wherein the at least one processor is operative to:
identify prospective accounts making said effort to appear on the at least one top page of the search engine results for the top customer searches or the product niches related to the client, further comprising wherein the at least one processor is operative to:
determine the top customer searches in search engines related to the products offered by client;
crawl Search Engine website for these top customer searches;
gather the account names and websites that were found in the search results for the top customer searches;
filter out existing accounts of the client; and
present those accounts who are appearing in search engine results who are not current accounts of the client.

29. A computer program product embodied on a nontransitory computer accessible medium, the computer program product comprising program logic, which when executed on at least one processor performs a method of identifying effort of at least one online account of a client is making to appear on a top page of at least one search engine for at least one of: at least one top customer search, or at least one product niche related to the client, the method comprising:
receiving client product information from the client;
receiving account information of the client,
wherein the account information comprises at least one of:
a name of the account advertising at least one client product, or
an actual account website advertising and advertising the at least one client product on the Internet;
determining at least one top customer search in at least one search engine related to the at least one client product offered by client;
crawling at least one search engine website for the at least one top customer search to obtain at least one search result;
gathering the account name and website found in the at least one search result for the at least one top customer search;
associating the at least one top customer search value with the account or the account website;
adding up a total number of times a given account appeared in the at least one top customer search;
grading each of the account based on the total number of times the account appeared in the at least one top customer search out of the total number of searches made; and
wherein said presenting information found on client products, further comprises at least one of:
presenting account level aggregate results, comprising at least one of the total number of times the account was found, or the grade of the account; or
providing functionality of sorting accounts based on efforts.

30. The computer program product according to claim 29, wherein the method comprises:
identifying prospective accounts making said effort to appear on the at least one top page of the search engine results for the top customer searches or the product niches related to the client, further comprising:
determining the top customer searches in search engines related to the products offered by client;
crawling Search Engine website for these top customer searches;
gathering the account names and websites that were found in the search results for the top customer searches;
filtering out existing accounts of the client; and
presenting those accounts who are appearing in search engine results who are not current accounts of the client.

31. The method according to claim 1, further comprising:
identifying at least one product placement of the at least one client product on at least one online website of at least one account, comprising:
identifying at least one website page of the at least one account where the at least one client product and at least one product of at least one client competitor are listed for sale or advertised;
gathering the at least one product placement of the client on the at least one website page of the at least one account, said gathering comprising:
crawling the at least one online website page of the at least one account;
finding where the at least one client product is ranked amongst all products listed for sale or as advertised on the at least one online website page of the at least one online website of the at least one account; and
saving the client product, and client product rank found on the at least one online website page of the at least one account, along with a date and a time of the gathering;
determining an average number of the at least one client products found and an average position of the at least one client products found over at least one time frame, comprising at least one of the at least one timeframe, a last 24 hours, a last week, or a last month; and
presenting at least one of:
the at least one client product found and the client product rank, along with the date and time of the gathering;
the average number of products found during the at least one time frame; or
the average position of products found during the at least one time frame.

32. The system according to claim 9, further comprising the at least one processor operative to:
identify at least one product placement of the at least one client product on at least one online website of at least one account, comprising the processor operative to:
identify at least one website page of the at least one account where the at least one client product and at least one product of at least one client competitor are listed for sale or advertised;
gather the at least one product placement of the client on the at least one website page of the at least one account, said gather comprising the at least one processor operative to:
crawl the at least one online website page of the at least one account;
finding where the at least one client product is ranked amongst all products listed for sale or as advertised on the at least one online website page of the at least one online website of the at least one account; and
save the client product, and client product rank found on the at least one online website page of the at least one account, along with a date and a time of the gathering;
determine an average number of the at least one client products found and an average position of the at least one client products found over at least one time frame,
comprising at least one of the at least one timeframe, a last 24 hours, a last week, or a last month; and
present at least one of:
the at least one client product found and the client product rank, along with the date and time of the gathering;
the average number of products found during the at least one time frame; or
the average position of products found during the at least one time frame.

33. The computer program product according to claim 17, wherein the method further comprises:
identifying at least one product placement of the at least one client product on at least one online website of at least one account, comprising:
identifying at least one website page of the at least one account where the at least one client product and at least one product of at least one client competitor are listed for sale or advertised;
gathering the at least one product placement of the client on the at least one website page of the at least one account, said gathering comprising:
crawling the at least one online website page of the at least one account;
finding where the at least one client product is ranked amongst all products listed for sale or as advertised on the at least one online website page of the at least one online website of the at least one account; and
saving the client product, and client product rank found on the at least one online website page of the at least one account, along with a date and a time of the gathering;
determining an average number of the at least one client products found and an average position of the at least one client products found over at least one time frame, comprising at least one of the at least one timeframe, a last 24 hours, a last week, or a last month; and
presenting at least one of:
the at least one client product found and the client product rank, along with the date and time of the gathering;
the average number of products found during the at least one time frame; or
the average position of products found during the at least one time frame.
